(19) United States
(12) Patent Application Publication
(10) Pub. No.: US 2008/0178149 A1
(43) Pub. Date: Jul. 24, 2008

(54) Inferencing types of variables in a dynamically typed language

(76) Inventors: James G. Peterson, San Jose, CA (US); Weng-Kiang Tjiang, Palo Alto, CA (US); John R. Allen, Los Altos, CA (US)

Correspondence Address: Silicon Valley Patent Group LLP, 18805 Cox Avenue, Suite 220, Saratoga, CA, 95070, US

(21) Appl. No.: 11/698,252

(22) Filed: Jan. 24, 2007

(51) Int. Cl. G06F 9/44

(52) U.S. Cl. 717/110

(57) ABSTRACT

A computer is programmed to identify types of variables, in a computer program which includes a number of variables that are used without any explicit indication of their type, by repeatedly performing at least propagation of types from variables' definitions to variables' uses and removal of unreachable code. Repetition of type propagation from definitions to uses and removal of unreachable code is one aspect of the invention. The repetition can be terminated differently in different embodiments. In many embodiments, the repetition is performed until no unreachable code is found.

### CROSS-REFERENCE TO COMPUTER PROGRAM LISTING APPENDIX

Appendix A contains the following files in one CD-ROM (of which two identical copies are attached hereto) and is a part of the present disclosure and is incorporated by reference herein in its entirety.

| Volume in drive D is CAT005US | |
|---|---|
| Volume Serial Number is 7A0E-BA7C | |
| Directory of D:\ | |
| 01/09/2007 06:51 PM | 324,281 ATSIMP.TXT |
| 01/24/2007 05:45 PM | 268,068 INTYPES.TXT |
| 01/24/2007 05:44 PM | 51,768 OPCPROP.TXT |
| 01/24/2007 05:43 PM | 44,636 TRTIDY.TXT |
| 01/24/2007 05:42 PM | 158,383 TYBAL.TXT |
| 5 File(s) | 847,136 bytes |
| 0 Dir(s) | 0 bytes free |

The above files contain source code for a computer program written in the C language for one embodiment of the invention that implement expression simplification (file ATSIMP which illustrates FIG. 3F), type propagation (file INTYPES which illustrates FIGS. 3A and 3B), constant propagation (file OPCPROP which illustrates FIG. 3C), unreachable code elimination (file TRTIDY which illustrates FIG. 4A-4F), and type balancing (file TYBAL), respectively. The attached CD-ROM is in IBM PC format, compatible with Microsoft Corporation's WINDOWS operating system.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

Dynamically-typed programming languages (such as the MATLAB® programming language) provide a powerful prototyping and development mechanism for programmers. Because such programming languages allow variables to take on the types of expressions that are assigned to them during program execution, programmers do not have to worry about details such as declaring the variable types or creating functions specific for a given variable type. Such languages support a programming style where programmers create (or in some cases, recreate) variables based on local contexts. Variables are frequently used in several different ways and for several different purposes because programmers basically just create variables as they need them.

While dynamically-typed languages support a relaxed programming style for programmers, they present significant challenges for the programming tools that support them. In particular, the most obvious methods for executing dynamically-typed languages provide extremely slow execution speeds. The result is that programmers cannot develop large applications in a dynamically-typed language because a program of any significant size requires too much time to run. The key to making dynamically-typed languages useful is optimizing their execution performance, increasing their execution speed and thereby decreasing the time required to execute programs of any significant size. The technology behind such execution improvement is commonly called “code optimization”, and the tool used to effect those improvements is commonly called a “code optimizer” or just “optimizer”.

Optimizers work by “statically” analyzing a program prior to its execution (or its “run-time”) to predict how the program will behave when executed on input data. Using those predictions, optimizers change the code that is executed so as to minimize the run time required to perform the calculation. In a very simplistic example, an optimizer will analyze a program that always computes and prints “7*6”, and realize that the program will always print “42”. In such a case, the optimizer will remove all instructions used in the computation, and leave in only the instructions required to print “42”. The effectiveness of an optimizer depends on its ability to predict, prior to program execution, how a program will behave when it executes.

Dynamically-typed languages present a significant challenge for optimizers, since by their very nature dynamically-typed languages hide information until execution time. Since the optimizer has less information prior to execution about how a program behaves when it executes, the optimizer is less able to statically predict program behavior and is thereby limited in its ability to improve program execution. One significant piece of information that is missing in dynamically-typed languages by their very definition is the “types” of variables. A compiler generates very different code for the addition of two integers than it does for the addition of two double precision numbers. Without knowledge of whether two variables that are being added are integer, double precision, or some other type, a compiler cannot generate code to do the addition directly. Instead, it must generate code that checks the types at runtime and selects the appropriate instruction sequence. Such checking sequences are very inefficient.

The MATLAB® programming language (as defined by the MATLAB interpreter version 14.3) is one example of a dynamically-typed language. Variables are not explicitly declared by users writing programs; instead, variables inherit their types from the type of the expressions assigned to them.

The MATLAB programming language is defined by the actions of the interpreter provided for the language by The MathWorks, Inc. Interpreters are useful programming tools for dynamically-typed languages, in that they provide a mechanism naturally suited for resolving typing questions during execution. Interpreters create and maintain an execution state environment (such as a symbol table) while they dynamically execute a program. This environment allows an interpreter at any point during execution to examine the state of the program, including the values and types that have been assigned to variables. This environment allows an interpreter to easily determine the types of variables while executing and to decide then the appropriate sequence of instructions to employ. Such code, while easy for the user to program, is very inefficient in terms of execution speed—the dynamic selection of code sequences imposes heavy overhead. As a result, users are limited in the sizes of the programs that they can write in such languages. As a general rule, the larger the program, the longer it takes to execute, and given the slow execution speed of interpreted code. Being able to compile programs written in dynamically-typed languages provides many benefits: improved execution speed, the ability to implement such programs in contexts where the virtual machine is not available, reduced memory, etc. Effecting that compilation, however, requires type information on variables and expressions. The invention disclosed in this application allows more programs written in dynamically-typed languages to be more efficiently compiled.

For clarity, this application will refer to the “type” of a variable or expression as that property which indicates what kinds of operations can be performed on the variable or expression, how those operations are performed, and how many times those operations are performed. Types are comprised of two pieces of information: a “base type” and a “shape”. The “base type” indicates what kinds of operations may be performed on the variable and how those operations will be performed. For example, a variable whose base type is integer can be used in operations such as addition, subtraction, multiplication, and division. In most computer languages, a variable whose base type is boolean typically cannot be used in these operations. The operations of addition, subtraction, multiplication, and division can also all be performed on double precision variables, but the method by which the operations are performed and the results are very different than the methods and results on integers. Examples of base types include integer, single precision, double precision (also called “real”), complex, fixed-point real, character, Boolean, and fixed-point complex.

The “shape” of a variable's type indicates the number of elements in the variable and how those elements are accessed. The simplest shape is “empty”, which indicates that the type contains no elements. A “scalar” type indicates only one element. More interesting are types with more than one element. Elements may be arranged linearly, so that each element is accessed by a single unique index (i.e. A(1), A(2), or A(n)). Such shapes are commonly referred to as “vectors”. Alternatively, the elements may be arranged as a collection of vectors, accessed by two indices (i.e. A(2,3) or A(n,n)). One index indicates which vector to select; the second element which element of that vector to select. Such a shape is called a “matrix”. Two special matrices are ones where there is only one vector but some number of elements in that vector, which is often called a “row vector” and ones where there is only one element in each vector but some number of vectors, which is often called a “column vector”. Similarly, the elements may be arranged as a collection of matrices, accessed by three indices: one indicating which matrix to select; one indicating which vector to select from that matrix; and one indicating which element to select from that vector. This process can be continued ad infinitum, leading to two essential parts of the “shape” of a type. One part is the number of dimensions, or how many indices are used to access the elements. The other part is the number of elements in each dimension (i.e. how many elements in each vector; how many vectors in each matrix; how many matrices in each 3-dimensional order object). The product of the number of elements in each dimension gives the total number of elements associated with the type. While examples are most frequently presented with just base type, the methods disclosed in this application apply to both base type and shape, and “type” refers to the combination of the two components.

Programs are comprised of variables, expressions, and statements. Variables represent symbols in a users program. An expression represents a collection of variables and the operations performed among them; for instance “a+b”. “a” and “b” are variables, and the entire “a+b” is an expression. Null operations are also allowed in the definition of an expression, so “a” is both a variable and an expression. Function invocations are also expressions. Statements are representations that affect control flow or perform assignments.

Most computer languages support types such as real, integer, character, Boolean, double, and complex. Not so common, but important in many contexts, is a fixed-point type. Fixed-point types are integers with an implied decimal point other than at the right of the integer. They have a specified number of bits to the left of the decimal, a specified number of bits to the right of the decimal, and may be signed or unsigned. Because fixed-point types have a specified precision, which cannot be increased without changing their semantics, they cannot be straightforwardly performed with integer or double arithmetic.

“Type lattice” is a term often associated with types (see the books by Cooper et al. or by Aho et al. for more details). Because some types can accommodate all the operations encompassed by other types (for instance, real numbers can be represented as complex numbers with a 0 imaginary component), types have a hierarchy. This hierarchy forms a lattice, where types that are higher in the lattice can perform the operations of those types underneath which can reach them. There are some types that alone in the lattice; ie., they are the only types that can perform their operations with the specific semantics. For instance, Booleans cannot be exactly emulated by other types.

The essential aspect of a dynamically-typed language is that a user does not have to explicitly specify (or “declare”) the type of a variable before the variables use. Instead, he simply assigns an expression to the variable; the variable then takes on the base type and shape of that expression. By assigning a value to the variable, the user is defining it, but not explicitly declaring it, and the same variable may have different types in different parts of a program. The concept of “define” is assigning a value to a variable. The concept of “declare” or “explicitly specifying” type is forcing a variable to be of a specified type. For instance, in C, variables are declared. If a variable is declared to be of type character, and an array of double precision values is assigned to it, it is an error and the program is incorrect. In MATLAB, if a variable is first used as a character variable, then an array of double precision values is assigned to it, the variable silently becomes an array of double precision.

In addition to being dynamically-typed, MATLAB is also polymorphic. This means that a function or statement written in it will work on variables with any type. That is, the statement “a=b+c” will execute for b and c being integers, double, complex, or fixed-point. This feature is very handy for functions, and is often associated with dynamically-typed languages.

Dataflow analysis frameworks, lattices, and techniques are well known in the art and are discussed fully in Chapter 4 of a book by Allen, Randy and Kennedy, Ken entitled “Optimizing Compilers for Modern Architectures”, Morgan Kaufmann publishers, 2002. This chapter is incorporated by reference herein in its entirety. The goal of dataflow analysis is to relate each “use” of a variable in the program (where “use” means any programming construct that may read or in any other way use the value that the variable contains in the computer's memory) to all possible “definitions” of that variable in the program (where “definition” means any programming construct that may set or change the value that the variable contains in the computer's memory) that can possibly set the value that the use may receive. “Definitions” are also commonly called “defs”. A “reference” (or “ref”) is any form of reference to a variable, either a use of the variable or a definition of the variable

It is well known in the art how to go from a definition of a variable to all locations in a computer program that may use the definition at execution time. Specifically, a “definition-use chain” is a data structure that is commonly used to perform such an operation. A definition-use chain is comprised of nodes and edges, where nodes represent variable references in the user's program, and an edge exists between two nodes when one node is a definition whose value may be used by the second node. In other words, an edge connects a definition to all possible runtime uses of that definition. While edges are normally indicated as going from definition to use, following the flow of data within the program, they may be as easily thought of as flowing from use to def (indicating a use that needs a value defined by the def), and a skilled artisan can easily construct data structures that allow both forms to be used. Note that the term “definition-use graph” is more appropriate than the traditional “definition-use chains” because “graph” more correctly characterizes the nature of the information the data structure contains. The definition-use chain (or graph) is essentially a scalar version of true dependences within a program.

Constructing definition-use edges within a single straight-line block of code is well known. One visits each statement in order in the basic block, noting the variables defined by each statement as well as the variables used by each statement. For each use, an edge is added to the definition use graph for that use back to the last exposed definition in the block of that variable—in other words, to every definition that reaches the use. Whenever a new definition is encountered for a variable, the new definition kills (i.e. over-writes) the existing definition, so that later uses are linked only to the new definition, not to the old. When the end of the block is reached, the definition use graph is complete.

Constructing a definition-use graph across a program comprised of more than a single straight-line block of code is more complicated. Standard art contains many different methods for computing definition-use graphs for programs containing control flow, many of which are summarized in Chapter 1 by Kennedy, Ken entitled “A survey of data-flow analysis techniques”, In a book by S. S. Muchnick and N. D. Jones, editors, “Program Flow Analysis: Theory and Applications,”, pp. 1-51. Prentice Hall publishers, 1981. At a high level, the methods all work by decomposing a program into simpler units (basic blocks, intervals, or others) and a control flow graph indicating the flow between the units. In a local pass, information is computed for each individual unit, regardless of the control flow among the units. Such information typically consists of sets of variables that are used, defined, killed (“kills” are definitions where all existing values in a variable can safely be assumed to be replaced), and reaches (“reaches” are definitions that can reach a given use). This local information is then combined into global information by propagating it along the control flow graph, using any of a number of dataflow propagation techniques (including iterative, interval, parse, and others). After the global information is available for the whole program, a definition-use graph can then be constructed by distributing the information back across the local units.

Most techniques for propagating dataflow information (i.e. iterative, interval, and so on) are theoretically based on framing the problem inside a lattice, also referred to in this document as a dataflow framework. A lattice, as defined in S. Muchnick, Advanced Compiler Design and Implementation, Morgan Kaufmann, 1997, consists of a set of values and two operations “meet” and “join”, both of which are closed, commutative, associative, distributive (in this document, but not in general), and monotonic (again in this document but not in general). A lattice also has two designated elements “top” and “bottom”. All the dataflow propagation techniques discussed so far can be applied to any problem that can be embedded in such a lattice. Propagating uses and definitions of variables is certainly one type of information commonly embedded in a lattice, but other information is as well. Much of the prior art described in this document is based on formulating a lattice based around other information than definitions and uses of variables.

When definitions and uses are propagated through a lattice, it is often convenient to abstract the resulting flow of data in a definition-use graph. Definition-use graphs can be embodied in a number of different forms, including linked lists, bit matrices, sets, bit vectors, etc. While the description of the techniques most often refers to a linked list of edges, skilled practitioners will readily recognize that all representations are equivalent in terms of the application of this invention.

“Type propagation” is a term used frequently in the literature, but with different meanings. “Type propagation” to many practitioners means propagating a type from a definition of a variable in one statement to a use of the variable in a statement, typically utilizing a data structure such as def-use chains or other representations of reaching information. This is the definition for “type propagation” assumed in this application. “Type propagation” to other practitioners means propagating the results of a type up an expression tree: i.e. if an expression is an addition of two integers, propagating the integer type from the variables to the expression node representing the addition. This application will refer to this operation as “type balancing”. “Type propagation” always proceeds from definitions to uses; type balancing occurs on expression trees, but not across statements.

“Entry points” and “entry nodes” are well defined terms in compiler literature. An entry point is a program location by which control may enter a function. In many programming languages, that is a single statement, such as in MATLAB, where the function header is the only entry point. In other languages, such as FORTRAN, multiple entry points into a procedure are supported, and any of those serves as an entry point. For analysis, compilers often simplify programs with multiple entry points by creating one unique entry point and by making the multiple entry points labels. When control reaches the unique entry point, it immediately branches to the appropriate label representing the former entry point to which control was to transfer. An “entry node” is the intermediate representation of the unique entry point.

Compilers typically work on programs by first translating them into an “intermediate representation” which is more convenient to work with than textual representations. There are many forms of intermediate representations in use. One of the primary reasons for intermediate representations is to facility “program transformations”. A program transformation is any transformation which changes the intermediate representation of a users program (hopefully in a beneficial way) without changing the semantics of his program. Commonly used program transformations include a) constant propagation (replaces uses of variables whose values are known to be constant with the constant value), b) constant folding (simplifying an expression, all of whose operands are constant, into a constant, e.g. 1+1 is replaced with 2), c) symbolic simplification (simplifying symbolic versions of known identities, e.g. i−i is replaced with 0), d) reassociation (changing the order in which associative operations are performed, e.g. 1+b−1 goes to 1−1+b), e) function evaluation (evaluation a function that has constant arguments), f) expression simplification (applying a wide range of techniques to make expressions simpler in form), g) identity replacement (replacing known identities, such as x+0 by x), h) unreachable code elimination (eliminating code which can never be executed), i) type propagation (propagating known types forward to their uses), j) type balancing (building up the types of expressions from the types of their components), and k) Boolean shortcircuiting (0 && x is replaced by 0).

Two common program transformations which are often confused in the literature are unreachable code elimination and dead code elimination. “Dead code” are statements which are executed during the flow of execution of the program, but whose results are never used. For instance, a program which always assigns a value of 5 to a variable “x”, but never uses “x” again, has dead code. “Unreachable code” is code that will never be executed in any flow of the program. Since it can never be executed, its computation cannot impact the program. The invention in this application is focused around unreachable code elimination, not dead code elimination.

“Worklist” is any data structure which supports two operations: “add” (remember the entry; if the entry has all been added and not retrieved, do nothing) and “retrieve” (return a “remembered entry” and no longer remember it). No relationship is implied on the order on which entries are retrieved. Examples of worklists include queues (entries are retrieved in the order in which they are added), stacks (entries are retrieved in the inverse order in which they are added), heaps (entries are retrieved based on a property), and priority heaps (entries are retrieved based on two properties).

The invention disclosed in this application is focused on solving the problem of uncovering the types of variables and expressions within a single procedure or function. An equally important problem is uncovering types across function calls; that is, procedure a calls procedure b, which calls procedure c: what are the types of the parameters in procedure c for this call chain, and what is the type if the return value that procedure c passes back. These two problems are obviously related (you must solve the problem of one function to answer the call chain, and you must solve the call chain to know what parameters to pass into called procedures). This application assumes methods are in place for solving the call chain problem that will deliver the types of parameters. Because the two problems are related, there are no assumptions about the order of the two procedures.

In “Compiling High-Level Languages to DSPs” in the May 2006 issue of IEEE Signal Processing, John R. Allen described a method for inferring types in a dynamically-typed program. An earlier implementation propagated type information, without performing repetition of acts that are part to this invention. Because this invention uses those methods as a basis for acts, FIGS. 1A-1F are used to describe this prior art. FIG. 1B is an example of a segment of a program which contains variables whose types are not explicitly specified. The variable “input” is considered as an input to the segment and the variable “output” is its output. Because the language used in FIG. 1B is polymorphic (as is MATLAB), this fragment will work for varable “input” being of any type, and “input” can be different types on different calls to this fragment. The variables “length”, “cos”, “pi”, and “dot” are builtin functions (that is, defined by the language and not changeable by the user) which return the number of elements in an expression (an integer), the cosine of an expression (complex), the value of pi (real), and the dot product of two vectors (result type depends on the input), respectively. The functions “all_integer” and “all_real return TRUE if all the elements of their inputs have integer/real values regardless of their actual type (for instance, all_integer(1.0) returns TRUE even though “1.0” is a double precision number—its value is integer). Finally, the functions “real” and “integer” convert their arguments—no matter what the type—into real and integer typed variables.

FIG. 1C shows the changes effected on the intermediate representation after the first execution of acts 100, 110, 120, and 140 for an instance called where the methods used for propagating types across the call tree have shown “input” to be an integer vector of 4 elements. During act 140, the methods of embodiments illustrated in FIG. 1A determine that the type of “n” in statement S1 is a scalar integer (indicated by the entry in structure 202 which represents the state of memory in the programmed computer) and propagate that information to the uses of “n” in S2. Knowing that the type of “n” is integer and that the type of “pi” is real scalar, type balancing will uncover the fact that the input argument to “cos” is a real vector of unknown length. Since “cos” called on real numbers returns real numbers, type balancing determines that the call to “cos” returns a real vector of unknown length. This fact is illustrated in FIG. 1C. The results of the “integer” function in S4 and the “real” function in S5 are known to be integer and real, respectively (although the shapes are not known) from the definition of the function. This means the base type of “cos_t” is known to be integer in S4 and real in S5, even though its shape is not known.

In accordance with several methods of the prior art, propagating one of definitions forward, the type of the use of “cos_t” in S7 is discovered to be either integer or real of unknown length. Assuming a meet function, the resulting type for “cos_t” in S7 will be a real vector of unknown length. The initial type propagation step is then complete.

Summarizing, the type information known at the end of the type propagation performed just once (illustrated in FIG. 1C): “n” as defined in statement S1 is a scalar integer; “cos_t” as defined in statement S2 is a real quantity with unknown shape, as are the uses of “cos_t” in S3, S4, S5, and S6; “cos_t” as defined in S4 is an integer quantity with unknown shape; “cos_t” as defined in S6 is a real quantity with unknown shape; the use of “cos_t” in S7 is a real quantity of unknown shape and the use of “input” in S7 is of unknown type, which yields a result type for “output” of unknown.

After propagating types, embodiments illustrated in FIG. 1A then perform program transformations as indicated in act 150. FIG. 1D shows the intermediate representation for the example program segment after these transformations. From call chain analysis and procedure tailoring, this embodiment of the invention determines that “input” is an integer vector of length 4. Function evaluation then replaces “length(input)” in S1 with the constant value 4. Constant propagation substitutes this value for “n” into all the uses of “n” in the intermediate representation of statement S2. Constant folding and function evaluation transform the intermediate representation for the expression “cos([0:2:2n−2]/n*pi)” into [1, 0, −1, 0]. This reveals that the definition of “cos_t” in statement S2 is constant; constant propagation replaces all uses of this variable reached by this definition (uses in S3, S4, S5, S6, but not S7) with the constant vector. FIG. 1D illustrates the resulting intermediate representation after these program transformations are effected.

Other program transformations effected in act 150 of embodiments illustrated in FIG. 1A include function evaluation and dead code elimination. Applying these transformations to the intermediate representation illustrated in FIG. 1D yields the intermediate representation illustrated by the program code 303 in FIG. 1E. The value of variable “n” computed in statement S1 is never used, so the statement comprises dead code and is eliminated by dead code elimination. The expression all_integer([1, 0, −1, 0]) in statement S3 is always TRUE; function evaluation detects this fact and transforms the program by replacing said expression with the value TRUE. Similarly, the expression “integer([1, 0, −1, 0])” in S4 is transformed to the value “[1, 0, −1, 0]”; the expression all_real([1, 0, −1, 0]) in statement S5 is transformed to TRUE; and the expression “real([1, 0, −1, 0])” in statement S6 is transformed to the value “[1.0, 0.0, −1.0, 0.0]”. FIG. 1E illustrates in program code 303 the result of these transformations on program code 300.

If type propagation (act 140) were to be re-applied to this intermediate representation, the results would be essentially identical to those obtained in FIG. 1C. The fact that call chain analysis has determined “input” is an integer vector of length 4 would cause the shapes of variables to become known, and there would no longer be a possibility of an unknown base type for “output”. However, the base type of “output” would still be real. The unknowns have been eliminated strictly because of the call chain analysis uncovering the type and length of “input”; an embodiment that performed this call chain analysis prior to the first instance of act 140 would have removed the unknowns during that time.

At this point, prior art has uncovered as much type information as is possible for it. Other optimizations may be invoked (for instance, FIG. 1F shows the result of applying unreachable code elimination to the fragment of FIG. 1E, which some embodiments perform), but no further type information would be uncovered by prior art methods known to the inventors.

### SUMMARY

A computer is programmed in accordance with the invention to identify types of variables, in a computer program which includes a number of variables that are used without any explicit indication of their type, by repeatedly performing at least propagation of types from variables' definitions to variables' uses and removal of unreachable code. Performance of type propagation after removal of unreachable code is a critical aspect of the invention. In some embodiments an operation, which includes type propagation and unreachable code elimination, is repeatedly performed in a loop. The repetition can be terminated differently in different embodiments. In many embodiments, the repetition is performed until no unreachable code is found.

Specifically, the computer first initializes the type of each variable to unknown, then transforms a representation of the program (while preserving its semantics) by use of certain program transformations in order to uncover and propagate types, from statements which define the type of the variables (with or without the user declaring the type of each variable) to statements which use the type of the variables. Upon completion of the program transformations, a changed representation of the computer program results which associates one or more types with a variable in the program whose type was previously unknown. At that point, the computer is programmed to check if the changed representation comprises unreachable code; if so, the unreachable code is eliminated from the changed representation. As noted above, type propagation is performed again after elimination of unreachable code in one aspect of the invention to develop more precise information about variables' types (for example, a variable that is initially associated with multiple types becomes associated a single type after unreachable code elimination followed by type propagation). Program transformations that are used in some embodiments include constant propagation and constant folding. In some embodiments, initial types other than unknown may be used for some of the variables, e.g. based on user input.

In some embodiments, the repetition of an operation including the described acts of initialization, program transformation, type association, and unreachable code detection refines the type information available in a representation of the computer program, so that a variable that is first associated with multiple types is later associated with a single type. Some embodiments of the invention construct a structure of definitions and uses for names in the computer program (also called “def-use chains” or a “def-use graph”), including the name of the variable whose type is made more precise.

In some embodiments, the computer is programmed to check if after each repetition of the operation every variable in the program representation is associated with a single type, and if so, some embodiments are further programmed to indicate the fact that the program is compilable to a user. Some embodiments proceed further to automatically compile programs where a final representation of the computer program associates every variable with a single type. If after the repetition of the described acts any variables are associated with multiple types, some embodiments of the invention identify one or more such variables to the user or report that the program is not compilable.

Some embodiments of the invention perform an extra repetition of the described operation after the termination condition has been reached (for example, after no unreachable code is detected). During this extra repetition, these embodiments use a different set of rules for associating types with variables than the rules used in earlier repetitions. Some embodiments indicate unsupported use of types only during this extra repetition of the operation.

### BRIEF DESCRIPTION OF THE DRAWINGS

FIG. 1A illustrates, in a high-level block diagram, a prior art process that receives a program that contains untyped variables, and determines the types of some number of those variables.

FIG. 1B illustrates a sample program of the prior art which is used to demonstrate the prior art process of FIG. 1A.

FIG. 1C illustrates a prior art intermediate representation in computer memory for the programmed computer executing the method of FIG. 1A on the example of FIG. 1B after step 13.

FIG. 1D illustrates the intermediate representation in computer memory for the programmed computer executing the method of FIG. 1A on the example of FIG. 1B after step 14.

FIG. 1E illustrates the intermediate representation in computer memory for the programmed computer executing the method of FIG. 1A on the example of FIG. 1B after step 14 followed by constant folding.

FIG. 1F illustrates the intermediate representation in computer memory for the programmed computer executing the method of FIG. 1A on the example of FIG. 1B after step 14 followed by constant folding and unreachable code elimination.

FIG. 2A illustrates, in a high level flow chart, acts performed by several embodiments of a computer programmed in accordance with the invention.

FIG. 2B illustrates the intermediate representation in computer memory for the programmed computer executing the method of FIG. 2A after a second execution of act 130.

FIG. 2C illustrates the intermediate representation in computer memory for the programmed computer after completion of the loop of FIG. 2A.

FIG. 2D illustrates the state of memory of a programmed computer during execution of the acts of FIG. 2A.

FIG. 3A illustrates, in a flow chart, acts performed by a programmed computer while executing act 130 of FIG. 2A.

FIG. 3B illustrates, in a flow chart, acts performed by a programmed computer while executing act 140 of FIG. 2A.

FIG. 3C illustrates, in a flow chart, acts performed by a programmed computer while executing act 150 of FIG. 2A.

FIG. 3D illustrates, in a flow chart, acts performed by a programmed computer while statically determining the type of a call to size(x).

FIG. 3E illustrates, in a flow chart, acts performed by a programmed computer while static evaluating a function ndims(x) with known value.

FIG. 3F illustrates, in a flow chart, acts performed by a programmed computer while performing constant folding and expression simplification.

FIG. 3G illustrates, in a flow chart, acts performed by a programmed computer to implement the “join” step illustrated graphically in FIG. 3H.

FIG. 3H provides a graphical view of a type lattice used in some embodiments.

FIG. 3I provides a list of program transformations effected by some embodiments during act 150 of FIG. 2A.

FIG. 4A illustrates, in a flow chart, acts performed by a programmed computer during execution of act 160 of FIG. 2A.

FIG. 4B illustrates, in a flow chart, acts performed by a programmed computer during execution of act 1230 of FIG. 4A.

FIG. 4D illustrates, in a flow chart, acts performed by a programmed computer during execution of act 1250 of FIG. 4A.

FIG. 4C illustrates, in a flow chart, acts performed by a programmed computer during execution of act 1240 of FIG. 4A.

FIG. 4E illustrates, in a flow chart, acts performed by a programmed computer during execution of act 1260 of FIG. 4A.

FIG. 4F illustrates, in a flow chart, acts performed by a programmed computer during execution of acts 1270 of FIG. 4A.

FIG. 5 lists a sample program and the resulting state of memory in a programmed computer for the intermediate representation following execution of the method illustrated in FIG. 2A.

FIG. 6A illustrates, in a flow chart, acts performed during embodiments that receive identified variables and associated types from a user.

FIG. 6B illustrates, in a flow chart, acts performed upon internal memory in FIG. 2D during performance of act 1760 of FIG. 6A.

FIG. 6C illustrates methods used by some embodiments for associating types with variables and for associating a single type with variables that are reported as having multiple types.

### DETAILED DESCRIPTION

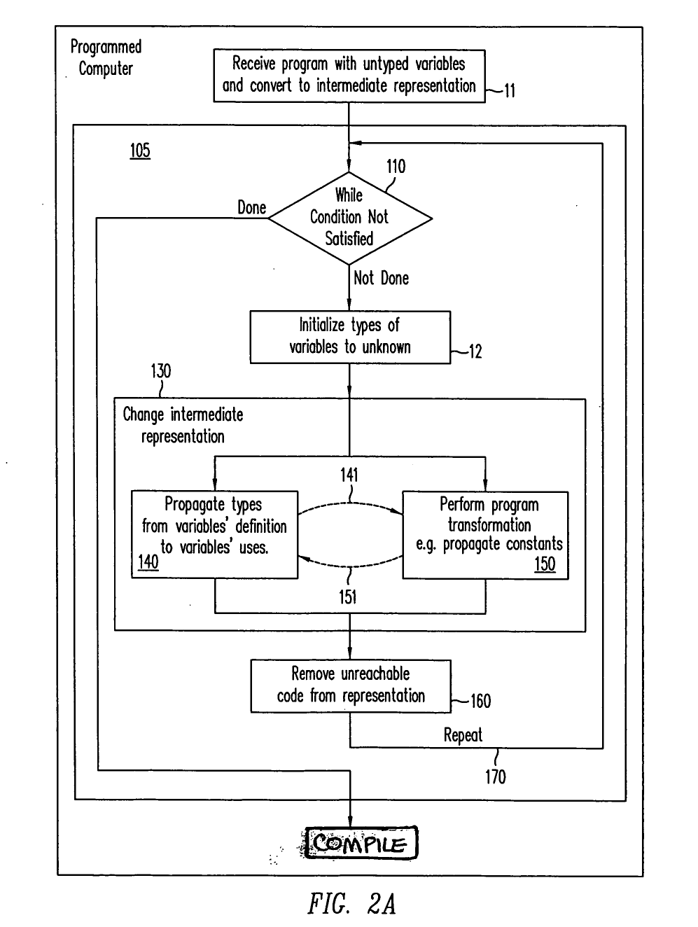

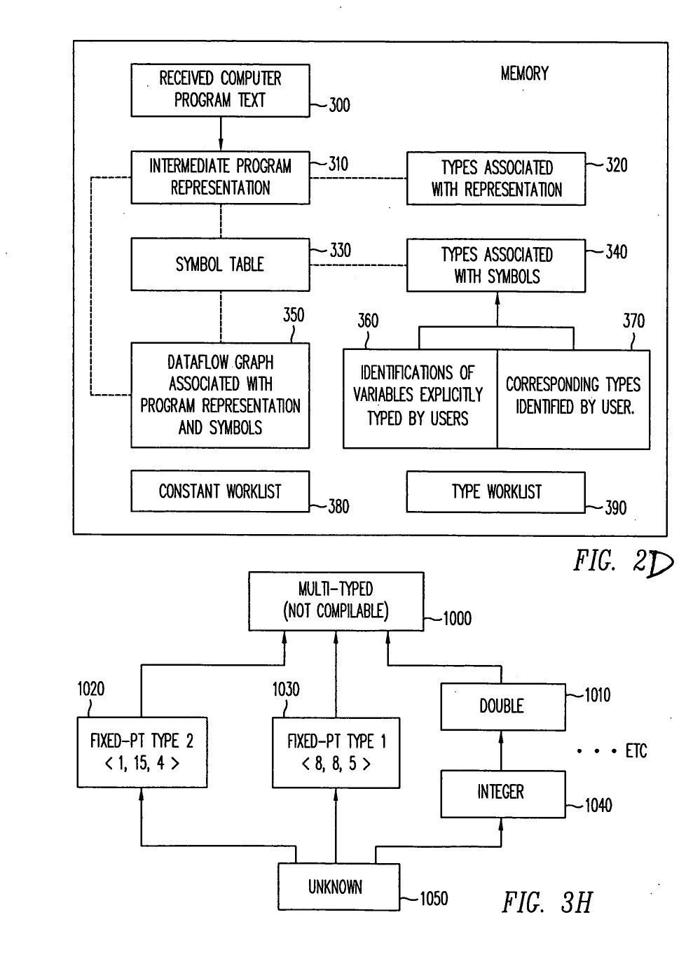

FIG. 2A illustrates, in a high level flow chart, the overall process in some embodiments of a computer that has been programmed in accordance with the invention. A user may prepare a computer program which contains one or more variables of unspecified type in a dynamically typed language such as MATLAB where the types of variables are not required to be explicitly declared. “Variables of unspecified type” includes at least three kinds of variables as follows: variables for which no type has been specified (that is, neither base type nor shape), variables where a base type has been specified but no shape, and variables where a shape has been specified but no base type. Such a program is received by the programmed computer in some embodiments of this invention in act 11 and the computer program is converted into a representation in memory, which is referred to as an “intermediate representation”. The exact form of the internal representation used is important in certain embodiments of this invention, and different forms of intermediate representations (such as Abstract Syntax Tree, quads, Static Single Assignment, Directed Acyclic Graphs to name a few) are used in different embodiments.

After receiving said program and converting it into a convenient intermediate representation, embodiments of a computer that has been programmed in accordance with this invention begin a repetition of an operation which includes type propagation and unreachable code elimination. Type propagation after unreachable code elimination is performed in some embodiments of the invention because inventors of the current application have found that such a sequence may yield more precise information and/or more accurate information about the type of one or more variables in certain computer programs which appear non-compilable if evaluated by traditional measures after these two acts are performed just one time. More specifically, type propagation after unreachable code elimination provides unexpected results, in the form of an intermediate representation which is compilable, although prepared from traditionally non-compilable computer programs. Neither the sequence nor the unexpected results are anywhere disclosed or suggested by any prior art which is known to the inventors of this invention.

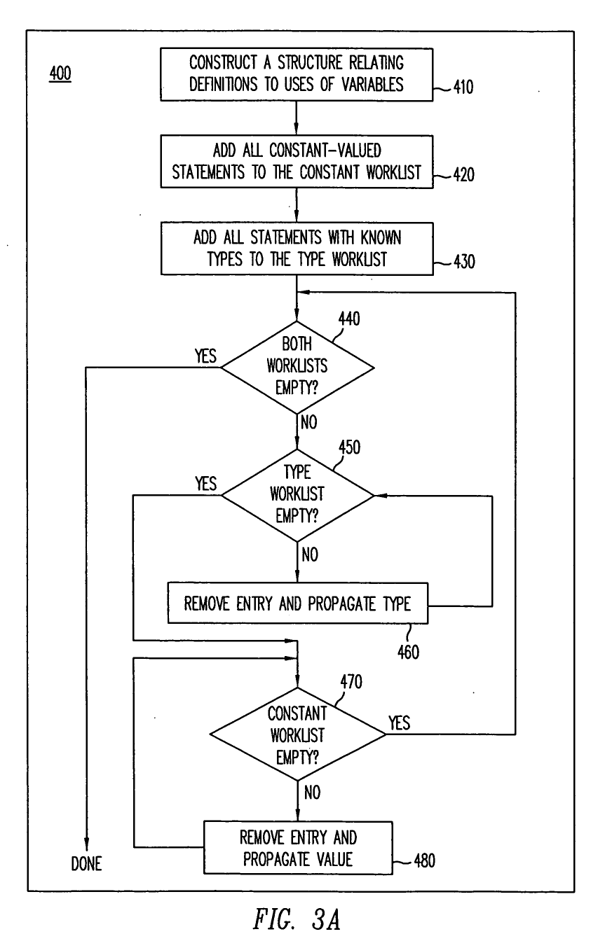

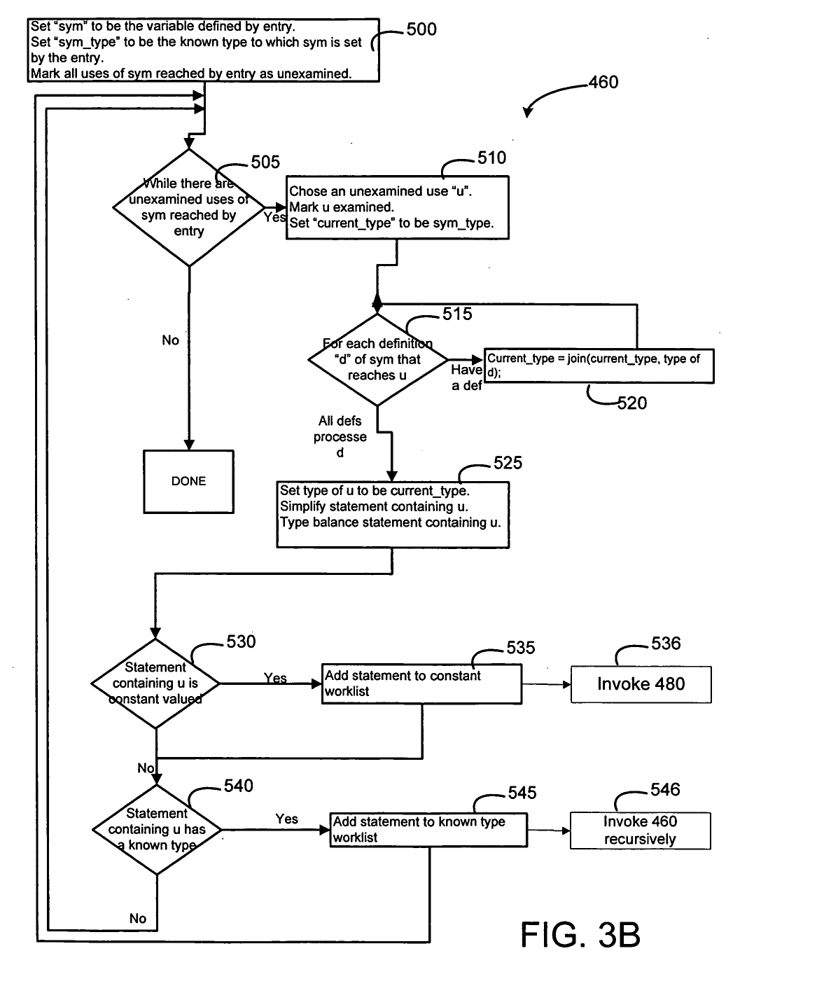

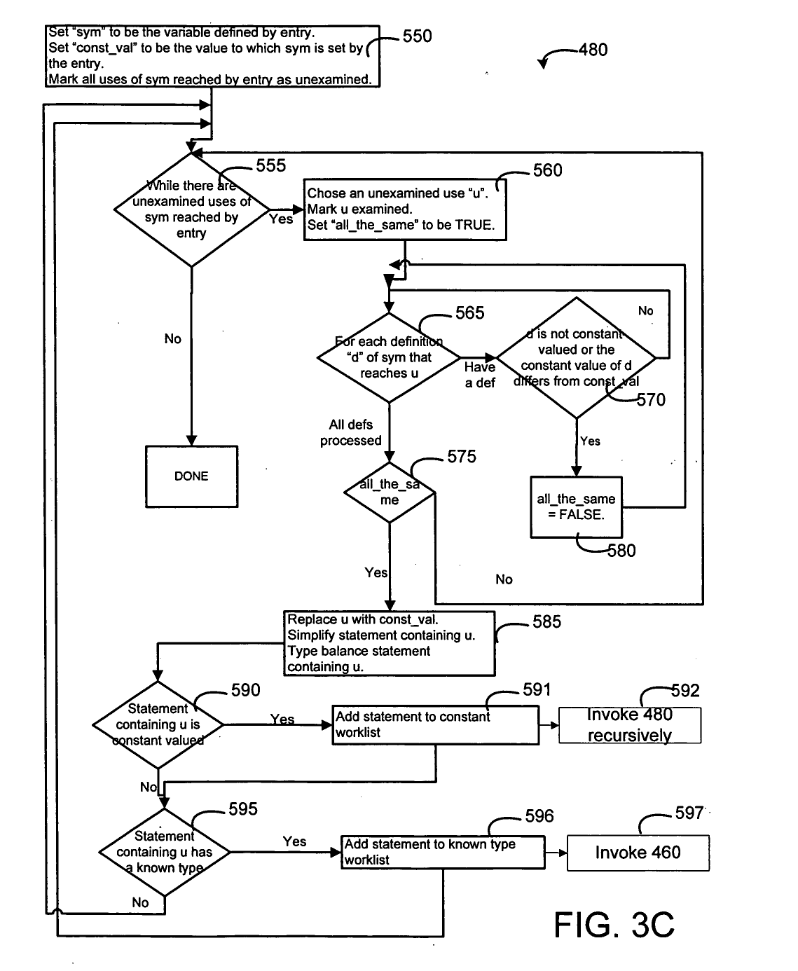

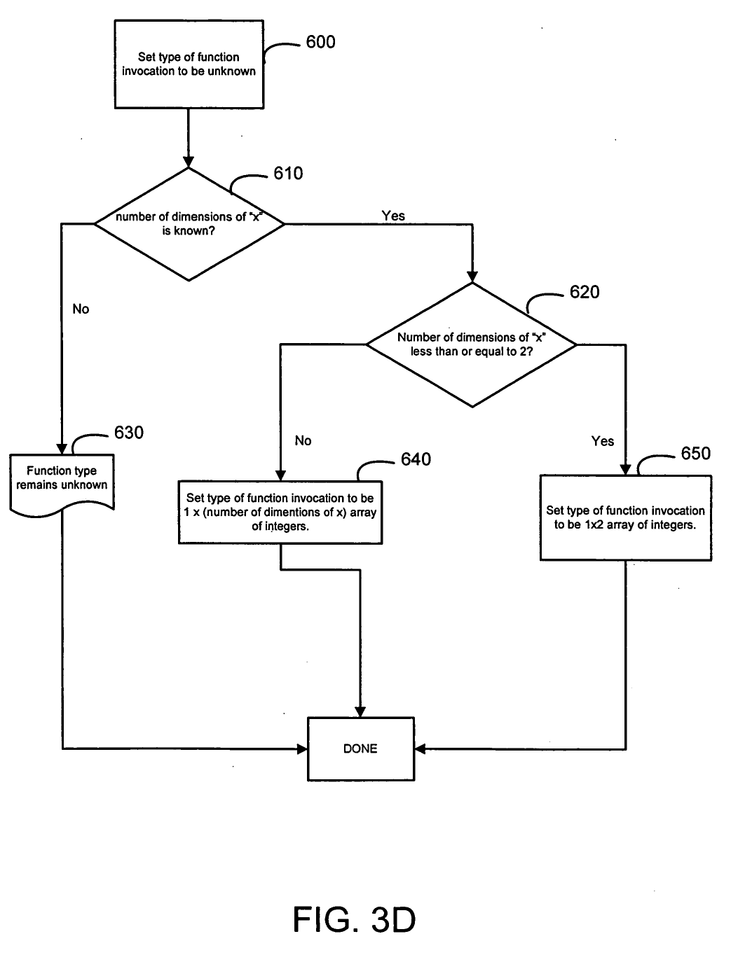

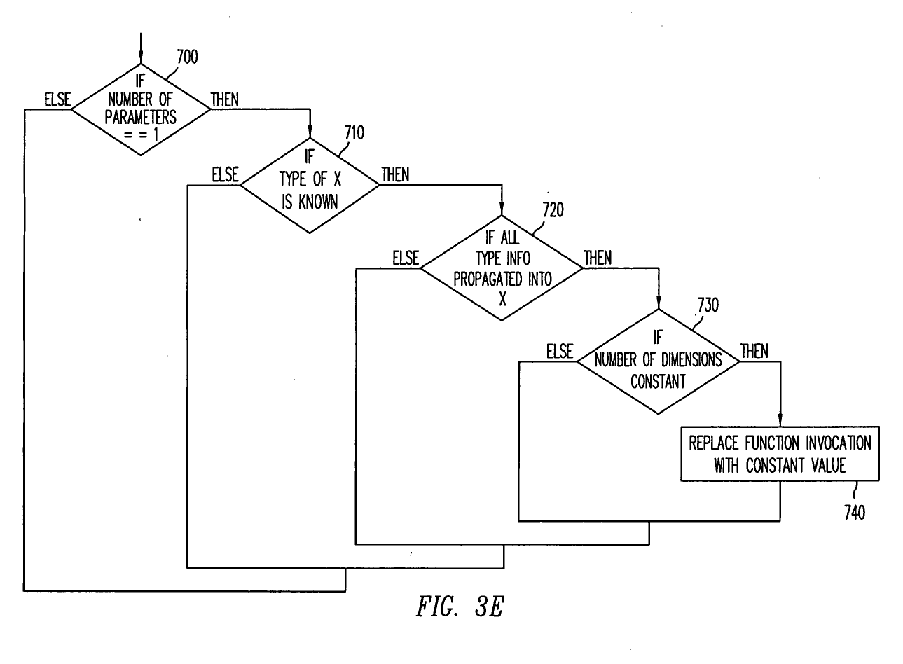

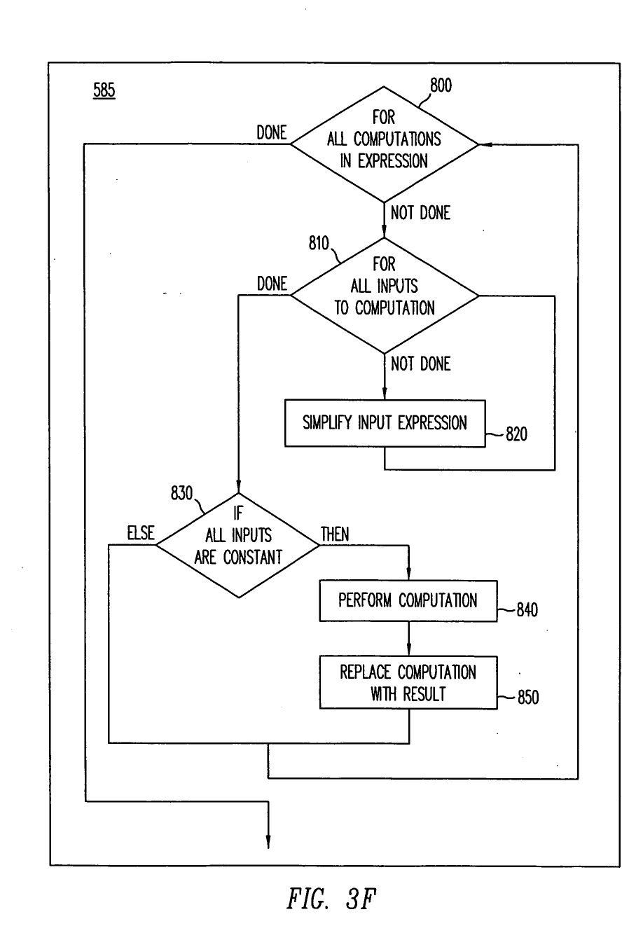

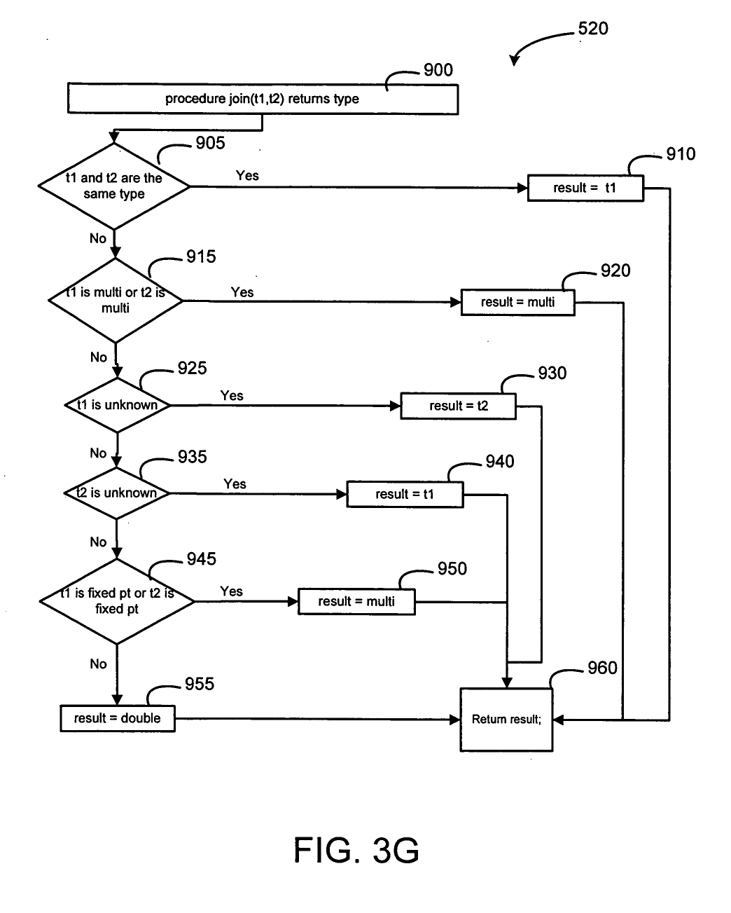

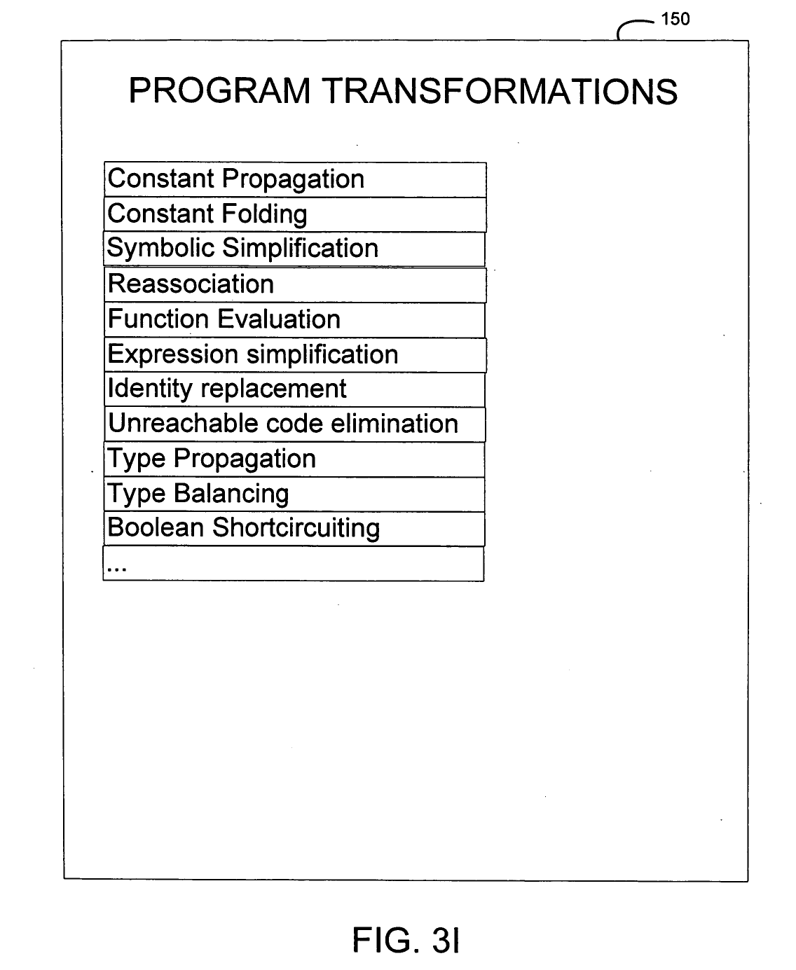

Some embodiments of the invention illustrated in FIG. 2A enter a repetition of the operation through act 110. So long as the termination condition is not satisfied (embodiments have different termination conditions), embodiments illustrated in FIG. 2A first initialize types of variables (act 12), then perform some number of program transformations on the intermediate representation (act 130). The program transformations change an intermediate representation of the computer program while preserving semantics of the original computer program. All embodiments shown in FIG. 2A propagate types from variables' definitions to variables' uses (act 140); some embodiments perform other program transformations as well (act 150). Illustrations of some possible program transformations for act 150 are presented in FIG. 3I. Order is not significant between acts 140 and 150; some embodiments execute act 140 first while others start with act 150. Different embodiments alternate acts 140 and 150 differing number of times, depending on the program transformations utilized in act 150. It is not a critical aspect of the invention that the same program transformations be employed in alternations of act 150; some embodiments employ different program transformations on different repetitions of the act of changing the intermediate representation specified in act 130. Some embodiments loop between acts 140 and 150 as shown on edges 141 and 151, and further detailed below in reference to FIGS. 3B and 3C.

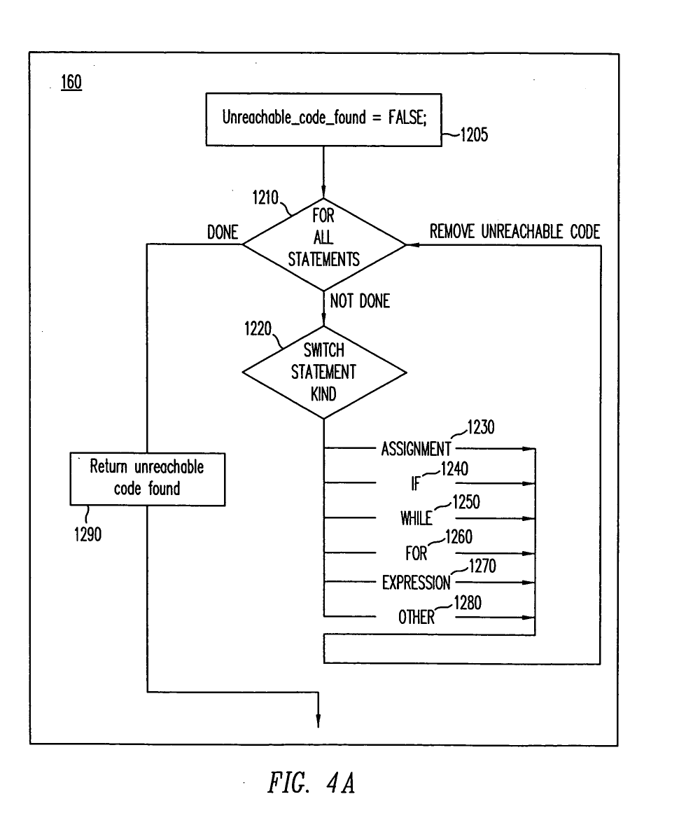

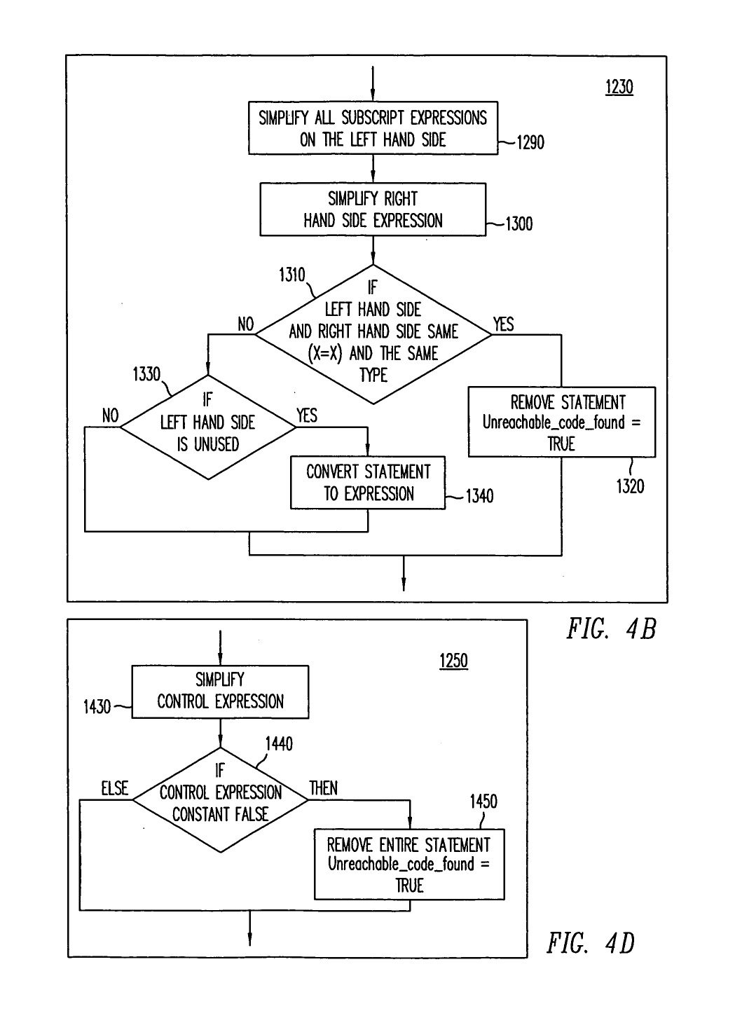

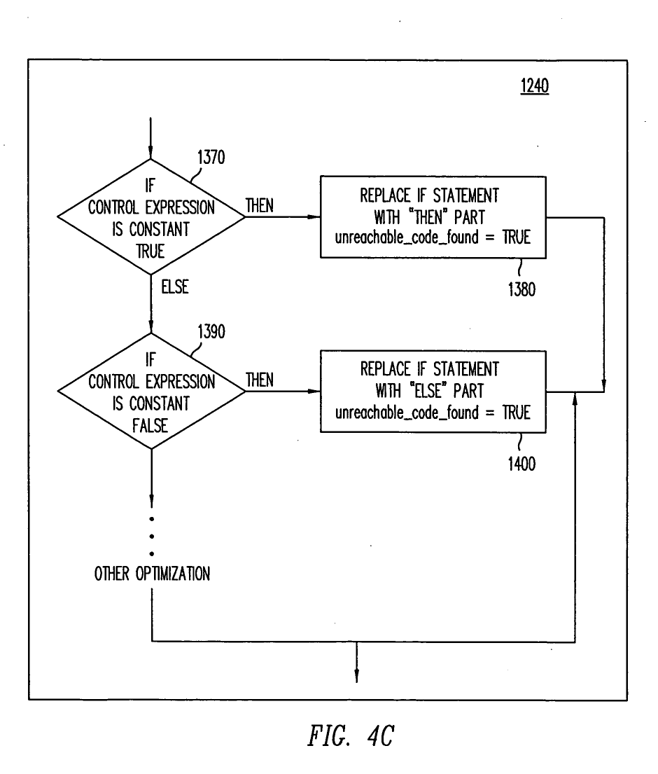

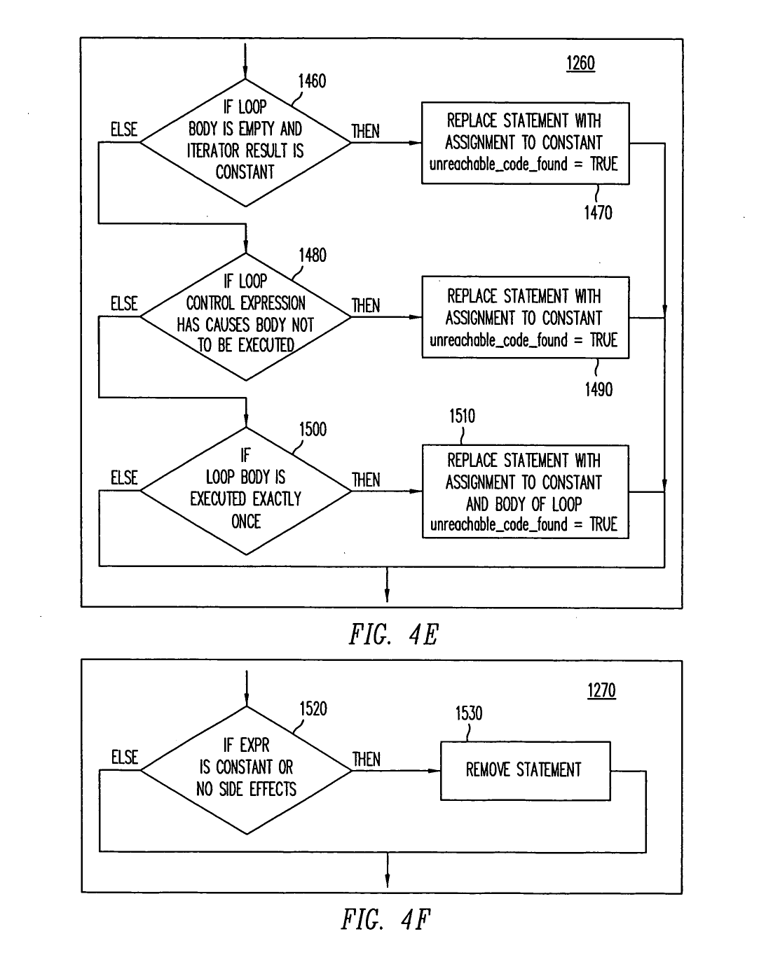

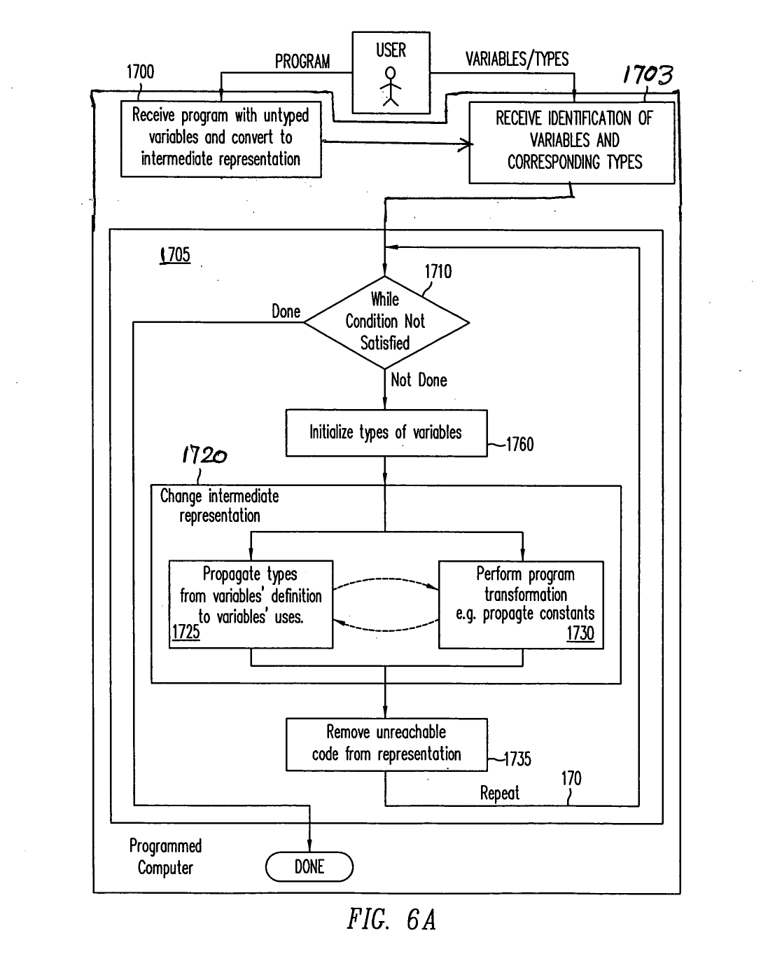

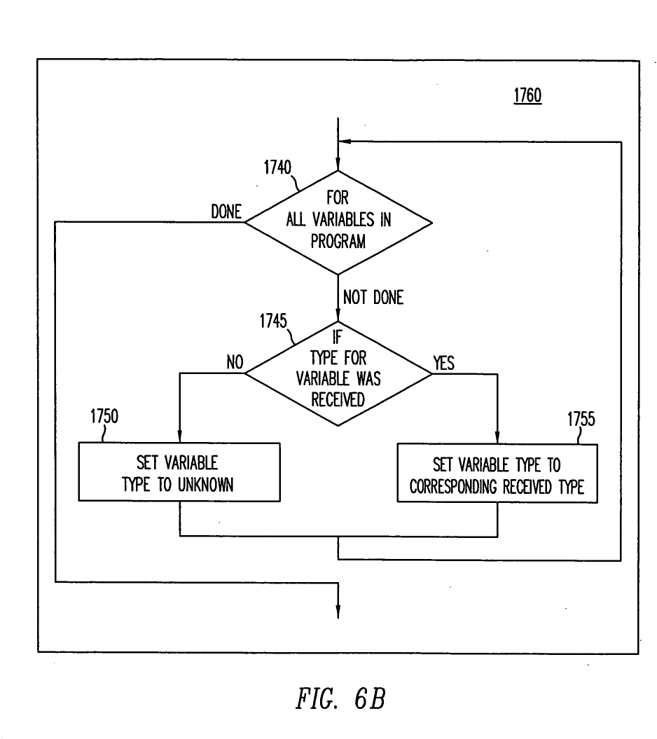

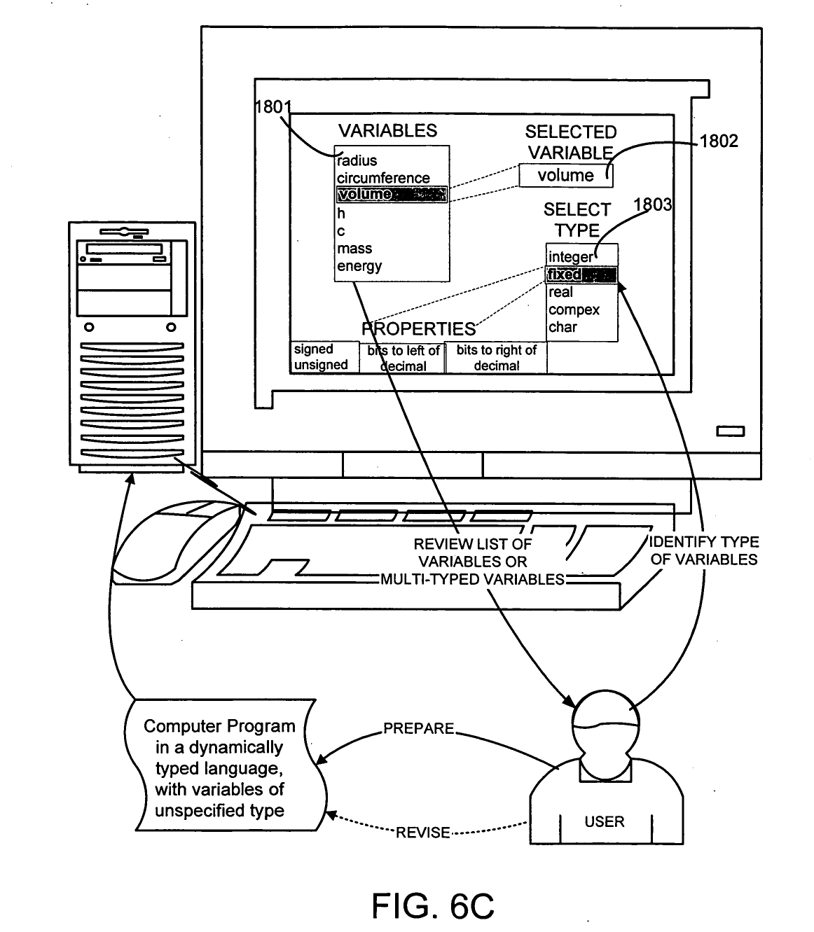

Once act 130 completes, embodiments illustrated by FIG. 2A eliminate in act 160 any code which cannot be reached by any possible execution path starting from a root of the intermediate representation of the computer program. Act 160 for some embodiments is elucidated in FIGS. 4A, 4B, 4C, 4D, 4E, and 4F. These embodiments then test whether completion has been reached in act 110. If not, acts 110, 12, 130, 140, 150, and 160 are repeated until the termination condition has been satisfied. Once satisfied, the typing process is complete. Upon completion of the typing process, some embodiments check whether each variable has a single type associated with it or not. If so, some embodiments report the program as compilable, and some embodiments proceed further to compile the program. If some variables have multiple types associated with them, some embodiments indicate to the user that the program is not compilable, and some embodiments provide to the user an indication of certain variables that are associated with multiple types. For example, the certain variables may be displayed to the user in list 1801 as shown in FIG. 6C.

In response to such indication by the programmed computer, the user may re-write the computer program (e.g. to explicitly indicate the types of certain variables or to rename multiple occurrences of one or more of the certain variables in the computer program), or alternatively the user may indicate to the programmed computer a specific type to be associated with one or more of the certain variables, depending on the embodiment. Hence, several embodiments repeat the just-described process shown in FIG. 2A, based on new information from the user, either in the form of a re-written computer program or based on explicit type information provided by the user for one or more of the certain variables.

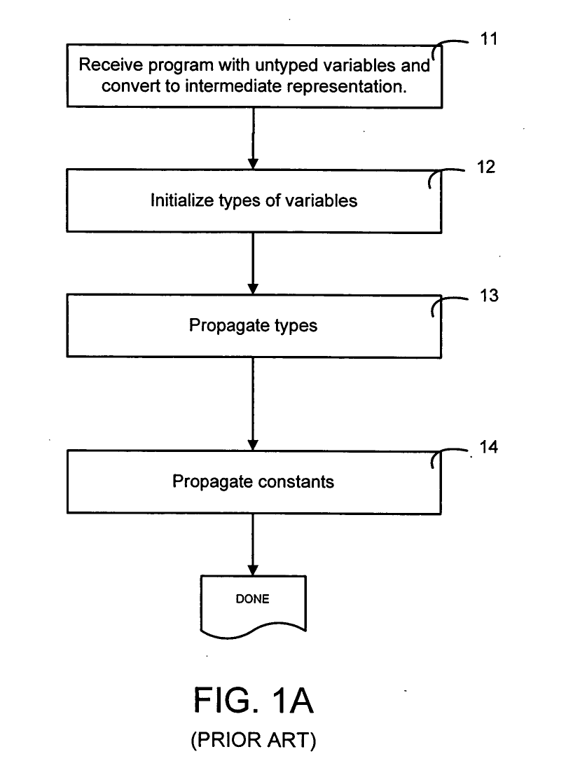

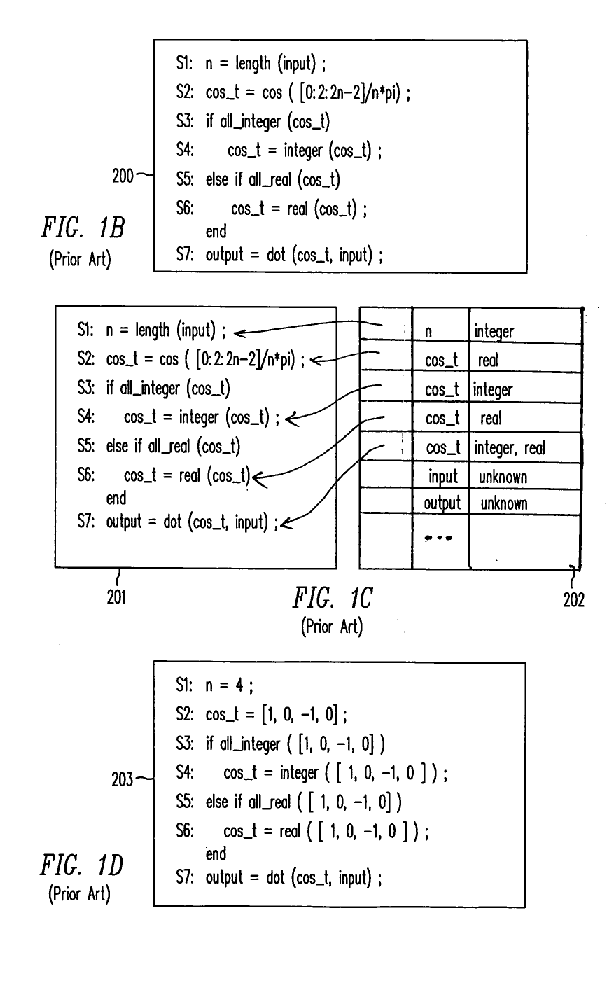

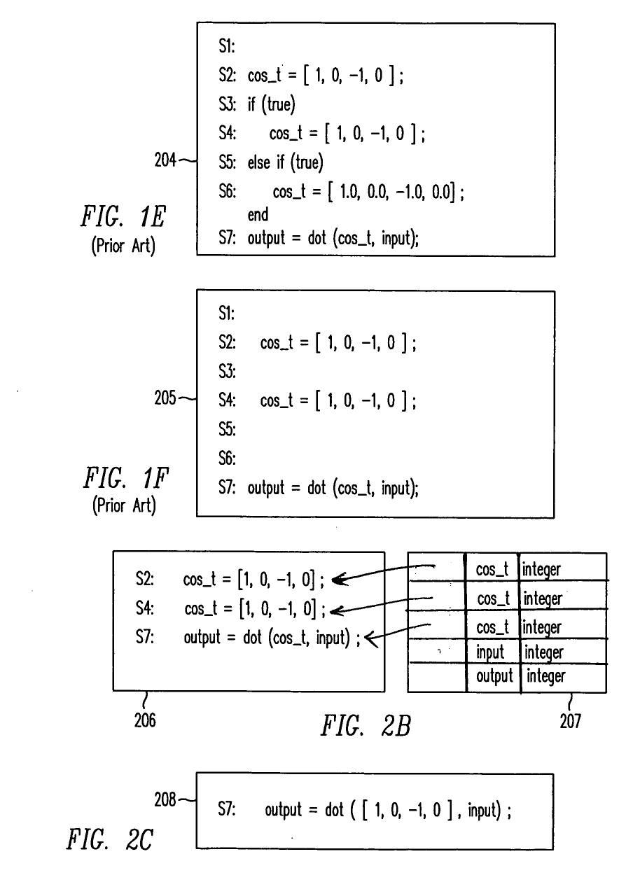

A computer may be programmed in some embodiments of the type shown in FIG. 2A to perform acts of 12 and 140 in the same manner as described above in reference to acts 12 and 13 in FIG. 1A. After unreachable code elimination (act 160), embodiments illustrated by FIG. 2A repeat (loop 170) the actions described so far until a termination condition is satisfied (act 110). Unreachable code elimination removes certain definitions that may initially cause a use to be associated with multiple types. The inventors recognize that type propagation after unreachable code elimination has more accurate information as a starting point because the certain definitions (which initially resulted in multiple types for a variable) have been removed from the intermediate representation of the computer program. In some embodiments, the termination condition described in act 110 is testing a flag that has been set to indicate that unreachable code has been eliminated; if so, the acts 12, 130, 140, 150, and 160 are repeated, and if not, the typing process is complete. Some embodiments test directly whether unreachable code exists within the program representation. Some embodiments test a counter indicating the number of unreachable statements which can be eliminated from the program representation.

The current inventors' recognize that elimination of unreachable code provides an opportunity to make traditionally uncompilable computer programs compilable by performance of type propagation again. The inventors have further recognized that traditionally compilable computer programs are more efficiently compiled after repetition of acts 140 and 150 and subsequent to act 160. Such repetition of acts 140 and 150 is nowhere disclosed or suggested in any prior art known to the inventors.

FIGS. 2B and 2C illustrate the advantages of the invention over prior art by reconsidering the example of FIGS. 1B-1F. The intermediate representation of the program fragment as displayed in FIG. 1F shows that the type associated with variable “cos_t” in S7 as held in the computer memory (the type association 340 in FIG. 2) is both integer and real. If the type lattice used for joins in the target architecture allows integer and real to be joined as real, then the programmed computer associates this variable with the type real, but if not, the fragment is determined to be not compilable. Even on architectures where the join is allowed and the fragment is compilable, the resulting code may not be the optimal possible code.

Wegman and Zadeck in “Constant propagation with conditional branches” (ACM Transactions on Programming Languages and Systems, Vol 13, No. 2, pages 181-210, April 1991) present a method for propagating constants and removing unreachable code that does not require repetition via looping as illustrated in FIG. 2A. This paper does not address type propagation for dynamically-typed languages, and specifically shape propagation, nor the combination of constant propagation and type propagation as illustrated in FIG. 2A. Their approach also requires a specific intermediate representation (SSA) which is unwieldy in languages that support numerous references to array references and sections (as most dynamically-typed languages do). SSA is advantageous if there are limited numbers of phi functions, but array references and pointers cause an increase in the number of phi functions, making analysis slow and memory-intensive.

Embodiments of FIG. 2A when presented with the fragment of FIG. 1B perform the same transformations on the intermediate representation as shown in FIGS. 1C, 1D, 1E, and 1F for the prior art. Effecting these transformations place these embodiments at act 160. After unreachable code has been removed in act 160 (resulting in the intermediate representation illustrated in FIG. 1F), embodiments of FIG. 2A loop via act 170 back to test 110. Since unreachable code was detected and eliminated, these embodiments repeat an operation which includes acts 12, 130, 140, 150, and 160. After this repetition, the computer memory holds an intermediate representation of the program fragment displayed in FIG. 2B. During the repetition of act 140 (subsequent to act 160), type propagation shows that “cos_t” is typed as an integer vector of length 4 in all its definitions and uses. Since “input” is also an integer vector of length 4, the type of “output” in S7 is an integer vector of length 4. Note that this information about the type of “output” is more precise than the type information obtained by the prior art method in FIG. 1A in the Background section, wherein “output” was typed as a real vector. Since integer operations are more efficient that real operations on many machine architectures, this additional precision in type information obtained by the method of FIG. 2A provides improved execution of the compiled program on many architectures, which is an unexpected result. On architectures where the type lattice does not permit joins of integer and real, this intermediate representation held in the computer memory of this program fragment (FIG. 2B) is compilable, whereas that obtained by prior art (FIG. 1D) is not.

Embodiments of FIG. 2A next perform program transformations (act 150). Note that while FIG. 2A illustrates embodiments wherein type propagation (act 140) is independent of and followed by program transformations (act 150), that sequence is not critical to the invention. Other embodiments start with act 150 followed by act 140. Further embodiments start with act 140 on some iterations and act 150 on other iterations of loop 170, as illustrated in one exemplary embodiment described below in reference to FIGS. 3B and 3C. Embodiments of FIG. 2A detect that “cos_t” is always a constant [1, 0, −1, 0] during act 150, and propagate that constant forward into statement S7. Doing so makes statements S2 and S4 dead; embodiments of FIG. 2A eliminate those statements by using dead code elimination. The resulting program representation is illustrated in FIG. 2C.

Embodiments of FIG. 2A next detect and eliminate unreachable code (act 160). The program representation illustrated in FIG. 2C contains no unreachable code. Upon repeating via act 170 the test condition in act 110, the fact that no unreachable code was detected causes the condition to be satisfied, terminating the loop of repetition. Since every variable in the example of FIG. 1B has been shown to have a single type, some embodiments indicate that the program is compilable. Some embodiments compile the program; some embodiments compile and execute the program. Some embodiments indicate to the user the type of each variable. Some embodiments generate a user-readable version of the final intermediate representation (FIG. 2C) for the user.

FIG. 2D illustrates some of the data elements stored in the computer memory and the relationships and data flow between said elements for some of the data stored for some embodiments of this invention. Specifically, the computer memory for some embodiments contains the received program text (structure 300) and an intermediate representation of that program text (structure 310). Intermediate program representations are arranged different ways in different embodiments; see a book entitled “Compilers: Principles, Techniques, and Tools”, 2nd Edition, 2006, by Alfred V. Aho, Monica S. Lam, Ravi Sethi, Jeffrey D. Ullman for examples. Many embodiments use a separate data structure for holding the variables in a program, represented by a symbol table (structure 330) in FIG. 2D.

Many embodiments store type information for both symbols and for program representation in separate tables as well, as illustrated by structures 320 and 340 in FIG. 2D. This is not a critical aspect of the invention, and skilled artisans will recognize in light of these disclosures that there are many different, functionally equivalent ways of storing program representations, variables, and types, and relating them to each other.

Some embodiments build a dataflow graph (also common called “def-use graph” or “def-use chains” in the literature) in the computer memory, as illustrated by structure 350. This structure links the definitions and uses of variables in the program representation, as indicated by the links from structure 350 to structures 310 and 330. This structure typically includes names for variables in the computer program. The essential aspect of this structure is that it relates the definitions of variables in the program representation to the uses of those variables; a skilled artisan will recognize in light of these disclosures that there are many ways of effecting this relationship.

Some embodiments (for instance, those illustrated in FIG. 6A) also hold in computer memory structures identifying variables for which a user has provided known types, as illustrated in FIG. 2D by structure 360 and 370. Embodiments that accept this information must be able to associate it with symbols, and since the specific program and intermediate representation is not a critical aspect of this invention, there are many ways of performing this association. FIG. 2D illustrates an association for embodiments where types are associated with a symbol table; skilled artisans will readily recognize there are many other methods for performing this association.

Some embodiments perform constant propagation and type propagation using worklists to drive the operation. These structures are illustrated by structures 380 and 390, and are held in computer memory, and used as discussed below.

FIG. 3A illustrates, in a high-level flowchart, one exemplary embodiment of act 130 of FIG. 1A where constant propagation is a program transformation used in act 150. This embodiment alternates between acts 140 and acts 150 of FIG. 2A via acts 141 and 151. Embodiments of FIG. 3A initiate the process of program transformation by constructing a data structure relating the definitions and uses of the variables in the program (act 410). Def-use chains are commonly used as a data structure to represent this relationship, but some embodiments use reaching bit vectors; some embodiments use static single assignment; and some embodiments use direct links in the program representation. In light of these disclosures, a skilled artisan can readily recognize many different methods for representing this information.

Embodiments of FIG. 3A initialize a worklist 380 for all the statements in the program that define a variable to be a constant value (act 420) and a worklist 390 for all the statements in a program that define a variable to have a known type (act 430). Once initialized with acts 410, 420, and 430, embodiments of FIG. 3A test whether the worklists 380 and 390 are empty in act 440. If so, the programmed method is terminated. If not, the type worklist 390 is checked in act 450. If it is not empty, then an entry is retrieved in act 460 and the entry's type is propagated via act 460, which is detailed more fully in FIG. 3B. Acts 450 and 460 repeat until the type worklist is empty. Embodiments of FIG. 3A then test the constant worklist 380 in act 470. If it is not empty, an entry is removed and its value propagated in act 480, which is detailed more fully in FIG. 3C. Acts 470 and 480 repeat until the constant worklist 380 is empty. The loop starting with act 440 is then reentered and repeated until both worklists 380 and 390 are simultaneously empty, at which point all constants and types have been propagated.

The order in which the constant worklist 380 and the type worklist 390 are checked is not significant in this invention. Some embodiments test the type worklist first; some embodiments test the constant worklist first. As detailed more fully in FIGS. 3B and 3C, some embodiments propagate constants while propagating types and some embodiments propagate types while propagating constants.

FIG. 3B further describes the process of propagating a type as indicated by act 460 of FIG. 3A in some embodiments of this invention. Type propagation as implemented in these embodiments takes a definition with a known type, and looks at all of the uses of the variable defined by that definition (acts 505 and 510). For each use, the programmed computer looks at all the definitions of that variable that reach the use. Since it is difficult to predict at compile-time which definition will be the one that reaches that use, the type being set on a given use in a particular statement must accommodate the types on all the definitions that reach it. This accommodation is accomplished by performing a join over all the incoming types (act 520). The best case is when all the types that may be associated with a variable are the same; the result is simply that type. If the incoming types are different, it may be possible that there is a single type that will support all of the incoming types. For instance, if the incoming base types are integer and real, real is used by certain embodiments of the programmed computer to accommodate both types legally (integer operations can be embedded in real operations, although real operations are typically more expensive). FIG. 3G, which is an illustration of act 520 for some embodiments, joins incoming types of integer and real to the single type real. If the incoming types cannot be accommodated by a single type, then multiple types are associated with the variable. Embodiments of FIG. 3G effect this association by having a special type “multi” which represents a multiple-typed symbol. The “multi” type indicates that the variable happens to be associated with two or more types but does not further indicate which specific types are associated. Some embodiments use different type lattices, where explicit entries demonstrate the exact types joined, e.g. a type “integer-real” indicates a type that must support both integer and real, and a type “integer-fixed-double” indicates a type that must support all of integer, fixed-point, and double.

Once the join of all incoming definition types is found, the type of the use is set to that join (act 525). Note that a use may be visited multiple times (in fact, it probably will) and that its type may change during those visits. In the early stages of type propagation, most definitions have unknown types. In embodiments that use the type lattice embedded in FIG. 3G and illustrated graphically in FIG. 3H, any incoming definition with an unknown type causes the use to have an unknown type. As the types of definitions become known, the unknown types of uses also become known.

Once the type of the use is set (act 525), the statement containing the use is both simplified (using any standard technique for expression simplification) and type balanced (using any standard technique for type balancing expressions or propagating types up the intermediate representation); both are performed in act 525. FIG. 3F illustrates simplification as performed by some embodiments. The goal of these transformations is to uncover more known types or constant-valued symbols. The statement containing the use is tested in act 530 to see if a new constant definition has been created. If so, the new constant is added to the constant worklist 380 from FIG. 3A to be propagated (act 535). One exemplary embodiment directly invokes constant propagation (FIG. 3C) to propagate that new constant forward (act 536). Act 536 is an illustration of branch 141 of FIG. 2A. Similarly, if type balancing has newly created a known type for a definition (tested in act 540), that newly created type definition is added to the type worklist from FIG. 3A (in act 545), and the newly created type definition is propagated forward (act 546). Act 546 is an illustration of branch 151.

Going through FIG. 3B in more detail, in act 500, temporary variable “sym” is set to be the symbol representing the variable defined by the statement referred to in the entry removed from the type work list in act 460. The temporary variable “sym_type” is set to be the known type which is set by said entry. All the uses of “sym” are then marked as unexamined.

Act 505 indicates that some embodiments of the invention then loop, repeatedly executing acts 510, 515, 520, 525, 530, 535, 540, 545, until all the uses of “sym” have been examined.

In act 510, one of the unexamined uses of “sym” is chosen, and designated as “u”. Said unexamined use “u” is marked as examined, and a temporary variable designated as “current_type” is set to “sym_type”.

In act 515 and 520, all the definitions which reach the use “u” are examined, and “current_type” is updated. Act 515 indicates a loop in which each definition reaching “u” is designated by the temporary variable “d”. In act 520, for each definition “d” indicated by the loop of act 515, the variable “current_type” is updated to the type determined by joining the “current_type” with the type produced by the definition “d”.

When all the definitions which reach “u” have been processed by act 515 and act 520, the type of “u” is set to “current_type”, the statement containing “u” is simplified and type balancing is performed on said statement.

In act 530, some embodiments of this invention determine if, after the program transformations applied during simplification in act 525, the statement which used to contain “u” now produces a constant value. If the result of said statement is now of constant value, in act 535 an entry referring to said statement is added to the constant work list.

In act 540, some embodiments of this invention determine if, after the program transformations applied during simplification in act 525, the statement which used to contain “u” now produces a known type. If the result of said statement now produces a known type, in act 535 an entry referring to said statement is added to the type work list.

FIG. 3C further describes the process of propagating a constant value as indicated by act 480 of FIG. 3A in some embodiments of this invention. The method effected by these embodiments follows standard techniques, unless disclosed otherwise herein. Once a constant entry has been removed from the constant worklist, all of the uses of its definition are examined (act 555). For each use, all the definitions that reach the use are checked (act 565). If all the definitions have the same, known constant value (checked in act 570), then that use can be replaced with the constant value. Embodiments illustrated in FIG. 3C use a flag “all_the_same” to represent whether all incoming definitions have known, constant, identical values, but a skilled artisan can easily recognize many different ways of representing the same information. If the incoming values are all known, identical constants (act 575), then the use is replaced with the constant value (act 585), and its containing statement is simplified and type balanced, using standard techniques. FIG. 3F illustrates simplification as performed by some embodiments. The goal, as with type propagation in FIG. 3B, is to uncover more constants and known types. If a new constant-valued definition has been created (tested in act 590), it is added to the constant worklist from FIG. 3A (act 591) to be propagated. One exemplary embodiment propagates it immediately by calling constant propagation (FIG. 3C) in act 592, which is an illustration of branch 141 of FIG. 2A. If the type of a definition has become known (tested in act 595), the definition is added to the type worklist from FIG. 3A (act 596) to be propagated. One exemplary embodiment propagates it immediately by calling type propagation (FIG. 3B) in act 597, which is an illustration of branch 151 of FIG. 2A.

Going through FIG. 3C in more detail, in act 550, temporary variable “sym” is set to be the symbol representing the variable defined by the statement referred to in the entry removed from the type work list in act 480. The temporary variable “const_val” is set to be the constant value which is set by said entry. All the uses of “sym” are then marked as unexamined.

Act 555 indicates that some embodiments of the invention then loop, repeatedly executing acts 560, 565, 570, 575, 580, 585, 590, 591, 595, and 596, until all the uses of “sym” have been examined.

In act 560, one of the unexamined uses of “sym” is chosen, and designated as “u”. Said unexamined use “u” is marked as examined, and a temporary variable designated as “all_the_same” is set to TRUE.

In acts 565, 570, and 580 all the definitions which reach the use “u” are examined one at a time to determine if they all cause the “u” to be of the same constant value. A loop over all the definitions “d” which reach “u” is indicated by act 565. In act 570, if “d” does not produce a constant value, or if the constant value produced by “d” differs from “const_val”, “all_the_same” is set to FALSE in act 580.

In act 575, if all the definitions which reach “u” do not produce the value “const_val” as indicated by “all_the_same” not being set to TRUE, the constant value is not propagated, and control returns to act 555 to examine the next unexamined use of “sym”. If “all_the_same” is true, control continues to act 585.

In act 585, the program is transformed such that “u” is replaced by “const_val”. The statement containing “u” is simplified and type balancing is performed on said statement, using any of the numerous techniques available from literature.

In act 590, some embodiments of this invention determine if, after the program transformations applied during simplification in act 585, the statement of the computer program which used to contain “u” now produces a constant value. If the result of said statement is now of constant value, in act 591 an entry referring to said statement is added to the constant work list.

In act 595, some embodiments of this invention determine if, after the program transformations applied during simplification in act 585, the statement which used to contain “u” now produces a known type. If the result of said statement now produces a known type, in act 596 an entry referring to said statement is added to the type work list.

As example of a part of the operation of type balancing performed on statements, FIG. 3D shows an example of function invocation typing. The function to be typed in this example is “size(x)” which returns an array of containing the number of elements in each dimension of x. The type of this result is an array 1×n of integers, where n is the number of dimensions of x.

In act 600, the type of the function invocation is initialized to unknown. In act 610, it is determined from the type of “x” if the number of dimensions of the array “x” is known. If the number of dimensions of the array “x” is unknown, then the function type remains unknown as indicated in act 630.

If the number of dimensions is known, in act 620 it is determined if the number of dimensions is less than or equal to 2. If the number of dimensions is less than or equal to 2, then in act 650, the type of the result of the function invocation is set to a 1×2 array of integers. If the number of dimensions is >2, then in act 640, the type of the result of the function invocation is set to 1×(number of dimensions of x) array of integers.

FIG. 3E shows an example of a part of the program transformation referred to as simplification. Specifically, this example shows function folding, in which a function invocation in the program is transformed into a constant value. In this example, the function invocation ndims(x) is transformed into a constant integer value.

In act 700, it is determined if the number of parameters input to the function is one. If the number of parameters is one, then in act 710 it is determined if the type of x is known. If the type of x is known, then in act 720 it is determined if all type information has been propagated to this use of x. If the condition of act 720 is true, then in act 730, it is determined if the number of dimensions of the type of the variable x is constant. If the condition of act 730 is true, then the program is transformed such that the function invocation ndims(x) is replaced by the integer constant “number of dimensions of x”.

FIG. 3F illustrates, in a flowchart, the process of transforming the program representation to implement expression simplification.

In act 800, some embodiments of this invention visit all the computations in the expression in a loop. For each computation in the expression, as illustrated in act 810, all input expressions to the computation are simplified, in some embodiments of this invention by recursive execution of the expression simplification method as indicated by act 820. In act 830, it is determined if all the inputs to the computation are constant. If the condition of act 830 is true, then in act 840 the computation is performed on using the constant inputs in the program representation. In act 850, the program representation is transformed by replacing the expression with the constant result of the computation as computed in act 840.

FIG. 3H provides a graphical illustration of a type lattice (which is prepared by the method illustrated in FIG. 3G) used by some embodiments of the invention. This lattice is used as the join step in act 520 of type propagation in FIG. 3B. In the graphical version of the lattice (FIG. 3H), the join of two base types is found by locating the two types in the lattice, then finding the lowest common type where they meet. For instance, the join of UNKNOWN (type 1050) with any other type (e.g. DOUBLE) is the other type (e.g. DOUBLE), because it is possible to move up the lattice from UNKNOWN to any other type. Programmatically, this represents the fact when combining UNKNOWN with any other type, the programmed computer's goal is to propagate the known type forward. Similarly, the join of INTEGER and DOUBLE is DOUBLE, since DOUBLE can be reached from INTEGER, representing the fact that INTEGER arithmetic can be encompassed by DOUBLE arithmetic. The lowest point at which any fixed-point type (FIXED_PT TYPE 1 or 2) meets any other type other than UNKNOWN is MULTI (type 1000), indicating that fixed-point arithmetic cannot be combined with any other type.

If a variable in the program can be set to several different types based on different possible execution paths, then the computer is programmed to combine these types to find a type which can hold all the possible different types to which the variable can be set. The join step on two types “t1” and “t2” is performed using the type lattice by determining the first point in the type lattice where paths from the two types meet.

One example of the operation of the type lattice can be seen if type t1 is integer and type t2 is double. The type lattice in FIG. 3H shows that the type integer in box 1040 can be represented by a type of double in box 1010, so that the first point in the type lattice where these two types meet is in box 1010 (double), so that the join step performed on the two types integer and double results in the single type of double.

Another example of the operation of the type lattice can be seen if type t1 is fixed point <1, 15, u>, a 16-bit unsigned number with 1 bit to the left of the binary point and 15 bits to the right of the binary point, box 1020, and type t2 is fixed point <8, 8, s>, a 16-bit signed number with 8 bits to the left of the binary point and 8 bits to the right of the binary point, box 1030. In this example the two types are first joined at the box 1000 which indicates that there is in some embodiments of this invention, no support in the computer's architecture to represent the join of these two types by a single type, and the program is determined not to be compilable.

Type lattices can be implemented in a number of ways, including direct coding, table lookups, and bit manipulations. FIG. 3G contains an implementation of the lattice of FIG. 3H used by some embodiments. In FIG. 3G, the type lattice is embedded in the code as IF statements. The simplest first test is act 905; if the two base types are the same, the type itself is the result of join. In act 915, if either of the types is multi (top of the lattice), the join can be no lower, so the result is multi. Acts 925 and 935 test whether either type is unknown; if so, the other type is the result of the join. Finally, in act 945, if either type is fixed-point and the types are not identical (ruled out in act 905), their nearest join point is multi.

FIG. 3I details transformations used by some embodiments in act 150 of FIG. 2A. These transformations are described in the background section.

FIGS. 4A through 4F illustrate a part of one embodiment of the operation of expression simplification, used in some embodiments of this invention.

FIG. 4A illustrates, in a high-level flowchart, the process of transforming the program to eliminate unreachable code in some embodiments, and elucidates more fully act 160 from FIG. 2A. The technique employed in this embodiment differs from the standard techniques in the literature. Standard techniques are used by the programmed computer to build a control flow graph, and mark sections that cannot be reached from the program root (see the book Engineering a Compiler”, by Keith Cooper, Linda Torczon, page 500; this entire book is incorporated by reference herein in its entirety). The methods employed by embodiments of FIG. 4A focus on incrementally recognizing unreachable code as expressions are simplified.

In this process the computer program is transformed so as to remove any statements from the intermediate representation which will never be executed. In some embodiments of this invention, the process illustrated in FIGS. 4A through 4F must return an indication that unreachable code elimination occurred during. In some embodiments of this invention, a flag is used which indicates that any unreachable code was eliminated. There are many other ways of accomplishing the same objective familiar to skilled practitioners, including but not limited to counters of the number of unreachable code eliminations which occurred, or determining if the intermediate representation changed between the start of the unreachable code elimination process and at the completion of said process.

In act 1205 illustrates the setting of the “unreachable_code_found” flag to false to indicate that no unreachable code has been found. Act 1210 illustrates the visiting of all statements in the program. For each visited statement, in act 1220, one specific transforming act is selected from acts 1230, 1240, 1250, 1260, and 1270, depending on the statement kind. Act 1280 indicates that there are a plurality of other possible statement kinds and corresponding transforming processes which produce the result of unreachable code elimination which were not included as a part of this example. Act 1290 indicates the return of the determination of whether or not any unreachable code was found and eliminated.

Act 1230 is selected if the statement to be examined is an assignment statement. FIG. 4B is an illustration of one possible embodiment of the removal of unreachable code on assignment statements for act 1230. In act 1290, expression simplification is applied to all subscript expressions on the left hand side of the statement. In act 1300, expression simplification is applied to the expression on the right hand side of the statement. In act 1310, it is determined if the assignment statement is of the form “x=x”, which is interpreted as the variable x is assigned to itself. If the condition in act 1310 is determined to be true, then the statement has no effect and can be removed in act 1320. In act 1320, the “unreachable_code_found” flag is set to true, indicating that unreachable code was found and eliminated.

If the condition in act 1310 is not true, then it is determined in act 1330 if the left had side is used. If the condition of act 1330 is true, then the statement is converted from an assignment statement to an expression statement in act 1340.

Act 1240 is selected if the statement to be examined is an IF statement. FIG. 4C is an illustration of part of one possible embodiment of the process of removal of unreachable code on IF statements. There are other possible conditions and optimizations which result in unreachable code elimination within if statements which have not been illustrated. Said other optimizations are illustrated by the text “OTHER OPTIMIZATION” in FIG. 4C.

In act 1370, it is determined if the control expression for the IF statement is always true. If the condition of act 1370 is determined to be true, then the program is transformed such that the IF statement and the else part of the IF statement are replaced by the then part of the IF statement in act 1380. Act 1380 also sets the “unreachable_code_found” flag to true.

In act 1390, it is determined if the control expression for the IF statement is always false. If the condition of act 1390 is determined to be true, then the program is transformed such that the IF statement and the then part of the IF statement are replaced by the else part of the if statement in act 1400. Act 1400 sets the “unreachable_code_found” flag to true.

Act 1250 is selected if the statement to be examined is a WHILE statement. FIG. 4D is an illustration of one possible embodiment of the unreachable code elimination on WHILE statements. In act 1430 expression simplification is applied to the control expression of the WHILE statement. In act 1440 it is determined if the control expression of the WHILE statement is always FALSE. If the condition of act 1440 is true, then in act 1450 the program is transformed so that the statement is removed. Act 1450 sets the “unreachable_code_found” flag to true.

Act 1260 is selected if the statement to be examined is a FOR statement. FIG. 4E is an illustration of one possible embodiment of the process of unreachable code elimination on FOR statements. In act 1460, it is determined if the loop body is empty and the result of the iterator computation is a constant. If the condition of act 1460 is true, then in act 1470 the program is transformed so that the FOR statement is replaced by an assignment of the iterator variable to a constant value, and the “unreachable_code_found” flag is set to true. In act 1480, it is determined if the loop control expression causes the body of the loop not be executed at all. If the condition of act 1480 is true, then in act 1490, the FOR statement is replaced with an assignment of the iterator variable to a constant value, and the “unreachable_code_found” flag is set to true. In act 1500 it is determined if the loop body is executed only once. If the condition of act 1500 is true, then in act 1510 the FOR statement is replaced by an assignment of the iterator variable to a constant value followed by the body of the loop, and the “unreachable_code_found” flag is set to true.

Act 1270 is selected by the programmed computer if the statement to be examined is an expression statement. An expression statement is a statement placeholder for holding expressions that are treated like statements. As an example, in C (and MATLAB), it is possible to write the statement “1;”. The result of that statement is “1”, but since nothing is done with it, the statement is determined to be “dead code”, which may be removed. Similarly, the expression statement “1+1;” is legal, but is also dead code. Expression statements that may be useful are function calls (i.e. “f(x)”) where the function has side effects, such as printing out a message or setting a global variable.

FIG. 4F is an illustration of one possible embodiment of the removal of unreachable code on expression statements. In act 1520 it is determined if the expression is constant or has no side effects. If the condition in act 1520 is true, then in act 1530 the program is transformed so that the statement is removed, and the “unreachable_code_found” flag is set to true.

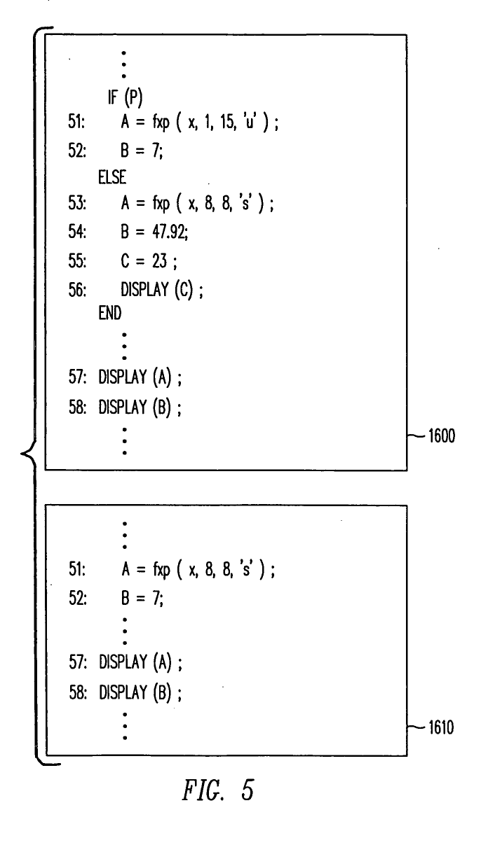

FIG. 5 illustrates an example of how repetitive application of the program transformations such as constant propagation followed by unreachable code removal result in substantial benefits in the determination of types during type propagation, thereafter in programs which contain unknown types. Box 1600 shows a segment of a larger program before any analysis has been done. In this segment, there are three blocks of statements, S1-S2, S3-S6, and S7-S8. The blocks of statements S1-S2 and S3-S6 are controlled by an IF statement with the control expression “p”.

In the first iteration of the process described in FIG. 2A, after the completion of act 130, variable “A” in statement S7 is multi-typed, as this is the lowest type in the type lattice of FIG. 3H which can hold the values of “A” from statements S1 and S3. Therefore after a single iteration of the process of FIG. 1A, the program cannot be compiled as it contains a variable which is associated with multiple types.

In the first iteration of the process described in FIG. 2A, after the completion of act 130, variable “B” in statement S7 is of type double, as this is the lowest type in the type lattice of FIG. 3H which can hold the values of “B” from statements S2 and S4. The program still contains references and code to set the value of C and display said value.

If the constant value of TRUE was propagated to the variable “p” in the control expression of the IF statement, then box 1610 illustrates the program after the completion of step 160 of FIG. 2A, unreachable code removal. The IF statement and the ELSE part (statements S3-S6) have been removed, and replaced with the THEN part (statements S1-S2).

If another iteration of the process of FIG. 2A takes place as indicated by act 110, the types of the variable “A” is now found to be fixed point <8, 8, s>. The type of the variable “B” is now found to be integer, and the variable “C” and its display have been removed from the program. There are now no multi-typed variables in the program so that it is determined by the programmed computer to be compilable. The type of variable “B” is now integer rather than double, and the variable “C” has been transformed away, resulting in the savings of computer memory space for storing these values resulting from the compilation of the computer program. The setting of the variable “C” and its display have also been removed, resulting in a reduction in the amount of computer memory space required for storing the program instructions required to perform these operations.

As another example of the improvements offered by a programmed computer performing the acts illustrated in FIG. 2A, consider a fragment where a variable “cos_t” is set to a row vector of length 5 along one branch and a 2×2 matrix along another branch. Both definitions reach a use. A programmed computer performing the acts illustrated in FIG. 1A would conclude that a 2-dimensional matrix with variable sizes for the base vector and the number of vectors is necessary. The dimension sizes would be 5 and 1 if the first branch is executed, and 2 and 2 if the second. If the 2×2 definition were in unreachable code, then repeating the operation would remove that definition. The embodiments performing FIG. 2A determine that a vector of length 5 is the type of cos_t. This determination creates much more efficient code.

FIG. 6A illustrates, in a high level flow chart, the overall process in some embodiments. The significant difference between FIG. 6A and FIG. 2A is that the user identifies some number of variables in the program and the computer is programmed to associate types with those variables (act 1705). In some embodiments, that association is performed in response to the user inserting information into the program text presented in act 1700. In some embodiments, that inserted information is in the form of pragmas; in some embodiments, it is in the form of comments; in some embodiments, it is in the form of declarations; in some embodiments, it is in the form of function calls. In some embodiments the computer is programmed to display to the user a list 1801 of variables from the user's computer program, as illustrated in FIG. 6C. FIG. 6C illustrates the association in some embodiments, where a user graphically selects into field 1802 program variables from list 1801 and interactively indicates the type of the selected variable as one of a predetermined set of types supported by the programmed computer and shown in drop down list box 1803. One aspect of act 1703 is an association of a type or types with some number of variables based on user input; embodiments use different methods ways of associating the types.

Obtaining user information that enables the programmed computer to associate types with variables is useful only if advantage is taken of the information. For that to happen, the equivalent of act 12 in FIG. 2A is changed in the embodiments of FIG. 6A. Act 1760 in FIG. 6A, as more fully elucidated in FIG. 6B, reflects those changes. Act 1705 causes changes to the memory of the programmed computer in structures 360 and 370, as indicated in FIG. 2D. Act 1760 in FIG. 6A causes the information stored in structures 360 and 370 to be conveyed to structures 340 and 350 (FIG. 2D), changing the memory of the programmed computer. Embodiments following FIG. 6B loop through these structures, transferring the information from one structure to the other.

In some embodiments of this invention, information identifying variables and their corresponding types is received as shown in act 1703, which may occur via a user interface of the type shown in FIG. 6C, depending on the embodiment.

After receiving said program, some embodiments of the invention begin a loop to determine the type of remaining variables of unknown type in said program. This loop is indicated in act 1710 and branch 170.

Some embodiments of this invention set up a data structure to contain the type of every variable in the program. In some embodiments of this invention, the types of all the variables in the program are set to types determined from the identification of variables and corresponding types from act 1703. FIG. 6B further illustrates this process.

Some embodiments of this invention then propagate types and constant valued variables throughout the program as indicated in act 1720. The types and constant values are propagated alternately, until all constant valued variables and known types have been fully propagated as illustrated in acts 1725 and 1730.

Some embodiments of this invention the perform transformations on the representation of the program to accomplish the removal of unreachable code from the program Said removal of unreachable code may cause a repetition of the acts 1760, 1720, 1725, 1730, and 1735 to produce improved accuracy or improved precision in types for the variables of the program.

FIG. 6B illustrates, in a high level flow chart, the overall process in some embodiments for initializing the types of the variables in act 1760 of FIG. 6A. Some embodiments of this invention loop through all the variables in the program as illustrated in act 1740. For each said variable, it is determined in act 1745 if the variable was in the list of received identified variables and has a corresponding received type. If the condition of act 1745 is false, then in act 1750 the type of the variable is set to unknown. If the condition of act 1745 is true, then in act 1755 the type of the variable is set to the corresponding received type.

Numerous modifications, variations, and adaptations of the embodiment described herein will be apparent to the skilled artisan in view of this disclosure, all of which are encompassed by the scope of this invention. In some embodiments, a computer readable storage medium is encoded with instructions to perform the method illustrated in FIG. 2A. In certain embodiments, such computer readable storage medium is prepared to contain software which performs type propagation after removal of unreachable code, as described above.

Some embodiments of the invention create and use a definition-use graph, as described in detail in U.S. application Ser. No. 10/826,978 filed by J. R. Allen on Apr. 16, 2004 which is incorporated by reference herein in its entirety (including the computer program appendix therein).

1. A method of identifying types of variables in computer programs, the method being performed in a computer, the method comprising:
receiving a computer program comprising a plurality of variables used without explicit indication of a type of each variable in the plurality of variables;
initializing the type of said each variable to unknown;
automatically changing an initial representation of the computer program while preserving semantics of the computer program, by repeated use of a plurality of program transformations;
wherein a changed representation of the computer program is obtained on completion of said automatically changing;
automatically associating a first type with a first variable in the plurality of variables, wherein said first type is obtained by type propagation of a second type from a definition of a second variable to a use of said second variable in an expression in said changed representation, wherein said expression is included in a statement in said computer program, said statement comprising said first variable and said second variable;
automatically checking if the computer program comprises unreachable code and eliminating said unreachable code if found;
in response to said eliminating, repeating each of: said initializing, said automatically changing, said automatically associating, and said automatically checking;
wherein a different type is associated with the first variable in a final representation of the computer program obtained after completion of said repeating.

2. The method of claim 1 wherein:
said plurality of program transformations comprise constant folding.

3. The method of claim 1 wherein:
said plurality of program transformations comprise constant propagation.

4. The method of claim 1 further comprising:
receiving identification of a group of variables in said plurality of variables;
receiving a group of types corresponding to the group of variables; and
after performing said “initializing the type of said each variable to unknown”, setting a type of each variable in the group of variables to a corresponding type in said group of types.

5. The method of claim 1 wherein at least one performance of said eliminating comprises:
automatically determining a portion of one of said representations to be not reachable from a beginning of said computer program and to be comprising all references to said second variable; and
automatically removing said portion thereby to obtain another representation devoid of said second variable.

6. The method of claim 1 further comprising:
compiling the computer program using said final representation.

7. A method of identifying types of variables in computer programs, the method being performed in a computer, the method comprising:
receiving a computer program comprising a plurality of variables used without explicit indication of a type of each variable in the plurality of variables;
initializing the type of said each variable to unknown;
automatically changing an initial representation of the computer program while preserving semantics of the computer program, by repeated use of a plurality of program transformations;
wherein a changed representation of the computer program is obtained on completion of said automatically changing;
automatically associating multiple types with a first variable in the plurality of variables, wherein said multiple types are obtained by type propagation of a second type from a definition of a second variable to a use of said second variable in an expression in said changed representation, wherein said expression is included in a statement in said computer program, said statement comprising said first variable and said second variable;
repeating said initializing and said automatically changing; and
automatically associating a single type with said variable by type propagation based on a representation obtained from repetition of said automatically changing.

8. The method of claim 7 further comprising:
automatically constructing a structure of definitions and uses for a plurality of names in the computer program, said plurality of names including a name for said variable.

9. The method of claim 7 further comprising:
automatically checking if said computer program comprises unreachable code and setting a flag to a first value if a result of said checking is true and setting said flag to a second value if the result of said checking is false; and
automatically eliminating said unreachable code if said flag is of said first value;
wherein said repeating is performed repeatedly while said first flag has said first value.

10. The method of claim 7 further comprising:
checking if each variable in said plurality of variables is associated with only a single type; and
indicating to a user that said computer program is compilable, if a result of said checking is true.

11. The method of claim 7 further comprising:
checking if each variable in said plurality of variables is associated with only a single type; and
identifying to a user at least one variable that is associated with multiple types, if a result of said checking is false.

12. A method of identifying types of variables in computer programs, the method being performed in a computer, the method comprising:
receiving a computer program comprising a plurality of variables used without explicit indication of a type of each variable in the plurality of variables;
initializing the type of said each variable to unknown;
automatically changing an initial representation of the computer program while preserving semantics of the computer program, by repeated use of a plurality of program transformations;
wherein a changed representation of the computer program is obtained on completion of said automatically changing;
automatically associating a first type with a variable in the plurality of variables, wherein said first type is obtained by type propagation of a second type from a definition of a second variable to a use of said second variable in an expression in said changed representation, wherein said expression is included in a statement in said computer program, said statement comprising said first variable and said second variable;
repeating said initializing and said automatically changing; and
automatically associating a second type with said variable by type propagation based on a representation obtained from repetition of said automatically changing.

13. The method of claim 12 wherein:
said first type is one of (double, complex) and said second type is integer.

14. The method of claim 12 wherein:
said first type is complex and said second type is double.

15. The method of claim 12 wherein:
said first type is shaped as an array of multiple dimensions; and
said second type is shaped as a vector of single dimension.

16. The method of claim 12 further comprising:
automatically checking if said computer program comprises unreachable code and setting a flag to a first value if a result of said checking is true and setting said flag to a second value if the result of said checking is false; and
automatically eliminating said unreachable code if said flag is of said first value;
wherein said repeating is performed repeatedly while said first flag has said first value.

17. The method of claim 16 further comprising, after said first flag has said second value:
automatically performing a final initialization of said type of said each variable to unknown;
automatically performing a final changing of representation of said computer program; and
automatically associating a final type with said variable.

18. The method of claim 17 wherein:
said associating of the first type with said variable is performed in accordance with an initial set of rules;
said associating of the second type with said variable is also performed in accordance with said initial set of rules; and
said associating of the final type with said variable is performed in accordance with a final set of rules.

19. The method of claim 17 further comprising:
automatically reporting unsupported use of types in accordance with a final set of rules, during said automatically associating of said final type with said variable.

20. A computer readable storage medium encoded with instructions to perform the method of claim 17.
